(19) United States
(12) Patent Application Publication
(10) Pub. No.: US 2018/0019476 A1
(43) Pub. Date: Jan. 18, 2018

(54) MODIFIED CHARGE COLLECTORS AND CELL CASES FOR ENHANCED BATTERY-CELL ROBUSTNESS

(71) Applicant: The Regents of the University of California, Oakland, CA (US)

(72) Inventors: Yu Qiao, San Diego, CA (US); Meng Wang, La Jolla, CA (US); Daniel J. Noelle, La Jolla, CA (US)

(21) Appl. No.: 15/546,918

(22) PCT Filed: Jan. 29, 2016
(86) PCT No.: PCT/US16/15736

§ 371 Date: Jul. 27, 2017

Related U.S. Application Data
(60) Provisional application No. 62/109,695, filed on Jan. 30, 2015.

(51) Int. Cl. H01M 4/70; H01M 2/34; H01M 10/42

(52) U.S. Cl. CPC H01M 4/70; H01M 10/4235; H01M 2/347; H01M 2/348

(57) ABSTRACT

A battery can include a cathode; an anode; a case; and an electrolyte; wherein the cathode and anode are formed of active material positioned on charge collectors. In one aspect, a battery includes a cathode comprising at least one charge collector; an anode comprising at least one charge collector; a separator; a cell case; and an electrolyte. The cathode and anode are formed of active material positioned on charge collectors. Examples of the aspect can include some, all, or none of the following features. The charge collector contains at least one weakening feature selected from the group consisting of bumps, notches, grooves, cracks, voids, sharp openings, folds, ridges, valleys, and hollow cross-section profiles.

### CLAIM OF PRIORITY

This application claims priority to U.S. Application No. 62/109,695, filed Jan. 30, 2015, the disclosure of which is incorporated herein by reference.

The present document relates to electrical batteries.

### STATEMENT AS TO FEDERALLY SPONSORED RESEARCH

This invention was made in the course of research partially supported by grants from the U.S. Department of Energy (DOE) (Grant No. DE-AR0000396). The government has certain rights in this invention.

### BACKGROUND

In the past, charge collectors, also called current collectors, in batteries are mostly smooth sheets of aluminum, copper, nickel or other metallic materials. Meshes and foams with smooth openings or pores/cells are occasionally used to reduce weight and materials cost. Many previous thermal runaway mitigation mechanisms work only when the temperature rises to an already dangerously high level.

### SUMMARY

In one aspect, a battery includes a cathode comprising at least one charge collector; an anode comprising at least one charge collector; a separator; a cell case; and an electrolyte. The cathode and anode are formed of active material positioned on charge collectors.

Examples of the aspect can include some, all, or none of the following features. The charge collector contains at least one weakening feature selected from the group consisting of bumps, notches, grooves, cracks, voids, sharp openings, folds, ridges, valleys, and hollow cross-section profiles. The charge collector is configured to be broken apart as the battery is subjected to mechanical abuse or thermal abuse or both mechanical and thermal abuse, thereby separating internal shorting sites. Configurations of the weakening features include at least one selected from the group consisting of straight lines, parallel lines, perpendicular lines, curved lines, dots, openings with wavy edges, sharp openings, hollow cross-sectional profiles, bridges, islands, and joints. Configurations of the weakening features include at least two selected from the group consisting straight lines, parallel lines, perpendicular lines, curved lines, dots, openings with wavy edges, sharp openings, hollow cross-sectional profiles, bridges, islands, and joints. The charge collector contains at least one locally heterogeneous material selected from the group consisting of weakening metals, temperature sensitive metals, alloys, ceramics, polymers, glass, carbon materials, elastomers, and composites. The charge collector is configured to increase impedance as the battery is subjected to mechanical abuse or thermal abuse or both mechanical and thermal abuse. The charge collector contains at least two locally heterogeneous materials selected from the group consisting of weakening metals, temperature sensitive metals, alloys, ceramics, polymers, glass, carbon materials, elastomers, and composites. The charge collectors of the cathode and anode are arranged in a mismatched placement with no overlapping area.

In one aspect, a system includes a cathode comprising a current collector; an anode comprising a current collector; a separator; a cell case; and an electrolyte. At least one of the group consisting of the cathode, the anode, the cell case, and the separator includes a failure feature configured to fail in response to at least one of the group consisting of thermal abuse and mechanical abuse.

Examples of the aspect can include some, all, or none of the following features. The failure feature is at least one of the group consisting of cracks, vacancies, wave shapes, protrusions, trenches, and indentations. The failure feature is at least one of the group consisting of locally anisotropic and heterogeneous. The failure feature is mechanically triggered upon mechanical abuse; and configured to increase impedance. The failure feature includes two or more different materials. One of the group consisting of the cathode, the anode, the cell case, and the separator includes a second failure feature configured to fail in response to at least one of the group consisting of thermal abuse and mechanical abuse. The failure feature and the second failure feature differ in at least one of the group consisting of pattern, shape, size, orientation, and material. The failure feature is created by surface treatment. The current collector includes alternating current collecting components and non-current-collecting components. The alternating current collecting components and non-current collecting components are at least one of the group consisting of locally anisotropic and heterogeneous. The failure feature includes a container containing mitigation material, wherein the container is configured to fail in response to at least one of the group consisting of thermal abuse and mechanical abuse by releasing the mitigation material. The mitigation material is at least one of the group consisting of thermal runaway mitigating material and fire mitigating material. The container is positioned in a location that is fixed relative to an electrode stack. The container is positioned in a location that is fixed relative. The container is positioned in a location external to the cell case and releases mitigation material into the battery cell in response to at least one of the group consisting of mechanical abuse and thermal abuse. The container is positioned in a location that is fixed relative a thermal management component. The thermal management component is coupled to a thermal management computer operating system. The container includes at least one of the group consisting of pouches, containers, pipes, ducts, channels. The container is an element of at least one of the group consisting of a thermal management system, battery cell support system, battery module, and pack wall. The container is an element of at least one of the group consisting of cleaning component, fuel-containing component, lubricant-containing component, and liquid-containing structure or component external to the battery cell.

Other features, aspects and potential advantages will be apparent from the accompanying description and figures.

### DESCRIPTION OF DRAWINGS

FIG. 1A shows an example of locally anisotropic/heterogeneous notches on current collector; one side of the current collector is smooth and the other side has a two-dimensional square-wave pattern.

FIG. 1B shows the cross section of locally anisotropic/heterogeneous square-wave-type surface feature of current collector.

FIG. 1C shows microscopy of locally anisotropic/heterogeneous square-wave-type surface feature of current collector.

FIG. 1D shows the temperature profiles of impact tests on a reference battery cell with smooth current collector and a battery cell with modified current collector.

FIG. 1E shows the damage mode of a modified current collector with locally anisotropic/heterogeneous square-wave-type surface features, after the impact test

FIG. 1F shows an example of elements of surface feature on current collector.

FIG. 1G shows the nodes and the paths that form an element.

FIG. 1H shows a few examples of locally anisotropic/heterogeneous surface features on current collector

FIG. 2A shows locally anisotropic/heterogeneous V-shaped surface feature on a current collector.

FIG. 2B shows a photo of the locally anisotropic/heterogeneous of a current collector modified by V-shaped surface features.

FIG. 2C shows the cross section of a locally anisotropic/heterogeneous V-shaped surface feature.

FIG. 2D shows the temperature profiles of impact tests on battery cells with reference current collector and current collector modified by V-shaped surface features.

FIG. 2E shows the damage mode of a current collector modified by V-shaped surface features, after an impact test.

FIG. 3A shows locally anisotropic/heterogeneous U-shaped surface features on a current collector

FIG. 3B shows microscopy of a current collector modified by locally anisotropic/heterogeneous U-shaped surface features

FIG. 3C shows the cross section of a locally anisotropic/heterogeneous U-shaped surface feature

FIG. 3D shows the temperature profiles in impact tests of battery cells with reference current collector and current collector modified by locally anisotropic/heterogeneous U-shaped surface features.

FIG. 3E shows the damage mode of a current collector modified by locally anisotropic/heterogeneous U-shaped surface features, after an impact test.

FIG. 3F shows an example of elements of surface feature on current collector.

FIG. 3G shows the nodes and paths in an element.

FIG. 3H shows a few examples of the cross sections of locally anisotropic/heterogeneous surface features.

FIG. 3I shows microscopic photos of examples of surface-feature patterns

FIG. 3J shows the effects of node distribution on the average peak temperature increase in impact tests

FIG. 3K shows effects of path on the average peak temperature increase in impact tests

FIG. 3L shows effects of double path on the average peak temperature increase in impact tests

FIG. 3M shows the effects of distance among nodes on the average peak temperature increase in impact tests

FIG. 3N shows the effects of the number of paths on the average peak temperature increase in impact tests

FIG. 3O shows the effects of the depth of surface features on the average peak temperature increase in impact tests

FIG. 3P shows the effects of the curvature of surface features on the average peak temperature increase in impact tests

FIG. 4A shows a precracked current collector.

FIG. 4B shows a current collector modified by precracks.

FIG. 4C shows the cross section of a precrack

FIG. 4D shows the temperature profiles in impact test of battery cells with reference current collector and current collector modified by precracks

FIG. 4E shows the damage mode of a precrack-modified current collector, after impact test

FIG. 4F shows examples of precracks of different depths and forms.

FIG. 5A shows a current collector modified by stress-concentrating vacancies.

FIG. 5B shows a photo of a current collector modified by stress-concentrating vacancies

FIG. 5C shows the cross section of a stress-concentrating vacancy in a current collector

FIG. 5D shows the temperature profiles in impact test of battery cells with reference current collector and current collector modified by stress-concentrating vacancies

FIG. 5E shows the damage mode of a current collect modified by stress-concentrating vacancies, after impact test

FIG. 5F shows some the examples of stress-concentrating vacancies of different cross sections and lengths.

FIG. 5G shows a current collector modified by locally anisotropic/heterogeneous protruding surface features.

FIG. 5H shows a few examples of locally anisotropic/heterogeneous protruding surface features of different geometries.

FIG. 6A shows a layered composite current collector, with mechanically-triggered components

FIG. 6B shows a current collector modified by mechanically-triggered glass components

FIG. 6C shows the damage mode of a current collector modified by mechanically-triggered glass components, after impact test

FIG. 7A shows a layered composite current collector, with mechanically-triggered components

FIG. 7B shows a current collector modified by mechanically-triggered polymer components

FIG. 7C shows the damage mode of a current collector modified by mechanically-triggered polymer components, after tensile test

FIG. 8A shows a layered composite current collector, with thermally-triggered components

FIG. 8B shows a current collector modified by thermally-triggered components

FIG. 8C shows the damage mode of a current collector modified by thermally-triggered components, upon heating.

FIG. 8D shows a current collector modified by mechanically-triggered and thermally-triggered components

FIG. 8E shows a current collector modified by mechanically-triggered or thermally-triggered components

FIG. 8F shows a locally anisotropic/heterogeneous current collector containing discontinuous dissimilar components

FIG. 8G shows a locally anisotropic/heterogeneous current collector containing continuous dissimilar components

FIG. 9A shows an example of mismatched current collectors of cathode and anode (top view).

FIG. 9B shows a photo of mismatched current collectors cathode and anode (top view).

FIG. 9C shows an example of mismatched fibrous current collectors of cathode and anode

FIG. 10A shows a schematic of mechanically or thermally triggered components modified battery cell

FIG. 10B shows a 2450 coin cell modified by a mechanically-triggered pouch

FIG. 10C shows the failure mode of a 2450 coin cell modified by a mechanically-triggered pouch, after impact

FIG. 10D shows the temperature profiles of reference battery cells and battery cells modified by mechanically-triggered pouches

FIG. 11A shows examples of mechanically or thermally triggered cell cases or cell case components of various shapes

FIG. 11B shows examples of locations of mechanically or thermally triggered cell cases or cell case components

FIG. 11C shows examples of surface features of mechanically or thermally triggered cell cases or cell case components

FIG. 11D shows examples of materials and constructions for mechanically or thermally triggered components

FIG. 11E shows reference and modified battery cell cases before impact test

FIG. 11F shows reference and modified battery cell cases after impact test

FIG. 12A shows schematics of mechanically or thermally triggered containers, components, and elements

FIG. 12B shows schematics of mechanically or thermally triggered containers, components, and elements placed in cell components

FIG. 12C shows a battery cell with a mechanically or thermally triggered modified container, before impact

FIG. 12D shows a mechanically or thermally triggered container

FIG. 12E shows a battery cell with a mechanically or thermally triggered modified container, after impact

FIG. 13A shows examples of the shapes, locations, and structures of mechanically or thermally triggered containers, components, and elements

FIG. 13B shows examples of shapes, location, and structures of mechanically or thermally triggered containers, components, and elements

FIG. 13C shows examples of surface features of mechanically or thermally triggered containers, components, and elements

FIG. 13D shows examples of materials and constructions for mechanically or thermally triggered containers, components, and elements

FIG. 14A shows a schematic of mechanically and signal triggered devices and components

FIG. 14B shows the working mechanism of mechanically and signal triggered devices and components

FIG. 14C shows a setup of mechanically and signal triggered devices on a 2450 coin cell

FIG. 14D shows a test setup of mechanically and signal triggered devices on a 2450 coin cell

FIG. 14E shows the temperature profiles in impact tests of a reference battery cell and battery cells with mechanically and signal triggered devices modified.

FIG. 15A shows schematics of mechanically or thermally triggered pipes, ducts, tubes, and channels

FIG. 15B shows examples of mechanically or thermally triggered pipes, ducts, tubes, and channels

FIG. 15C shows a mechanically triggered pipes modified 2450 coin cell before impact test

FIG. 15D shows mechanically triggered pipes

FIG. 15E shows a mechanically triggered pipes modified 2450 coin cell after impact test

FIG. 16A shows examples of possible shapes and cross-sections of mechanically or thermally triggered pipes, ducts, tubes, and channels

FIG. 16B shows possible locations and constructions of mechanically or thermally triggered pipes, ducts, tubes, and channels

FIG. 16C shows possible surface features of mechanically or thermally triggered pipes, ducts, tubes, and channels

FIG. 16D shows possible materials and constructions of mechanically or thermally triggered pipes, ducts, tubes, and channels.

### DETAILED DESCRIPTION

Damage to a battery can cause the temperature of the battery to rise due to interactions of the damaged components of the battery. This temperature rise can give way to a process sometimes called “thermal runaway” in which temperature of the battery rises exponentially, often until the battery catches fire or otherwise fails in a dangerous way (e.g. by spilling dangerous chemicals, deforming, supplying anomalous electrical current).

Described here are design features that can be used to mitigate or eliminate the risk of thermal runaway. Some of these features involve designing components of the battery so that specific components fail in a controlled way, thereby preventing the battery from failing catastrophically (e.g., by catching fire) and damaging nearby people and property. The techniques described here may be used independently or together with each other and/or other known and new techniques for preventing thermal runaway. In doing so, batteries with increased safety may be designed and fabricated. In general, it is desirable that as a battery is impacted or is subjected other forms of mechanical or thermal abuse, temperature rise can be suppressed as early as possible.

Here we show components of battery cells or battery modules/packs that can be mechanically or thermally triggered to mitigate thermal runaway at the battery cell level, before reaching dangerous levels. In some examples, the battery components so designed include but are not limited to current collectors, battery cell cases, additional pouches, and cooling pipes. For example, by creating weakening notches, cracks, sharp openings, ridges, folds, etc. in the charge collector, the internal shorting site in the electrode can be broken apart from the rest of the battery system, thus the internal impedance may be largely increased and thermal runaway suppressed. In some examples, modified battery cell cases or charge collector may contain mitigating material (e.g., thermal runaway mitigating material, fire mitigating material); the liquid containing components may also be placed inside the battery cell as pouches. When the battery is subject to mechanical or thermal abuse, the container may fail, releasing the contained mitigating material.

### EXAMPLES

### Example 1

### Current Collector Modified by Locally Anisotropic/Heterogeneous Channel Features

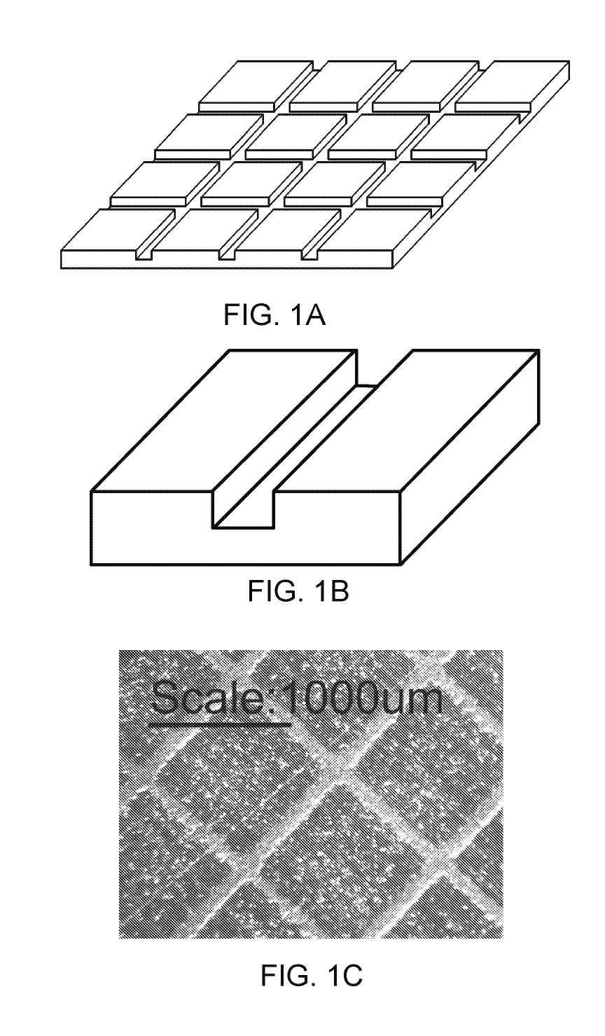

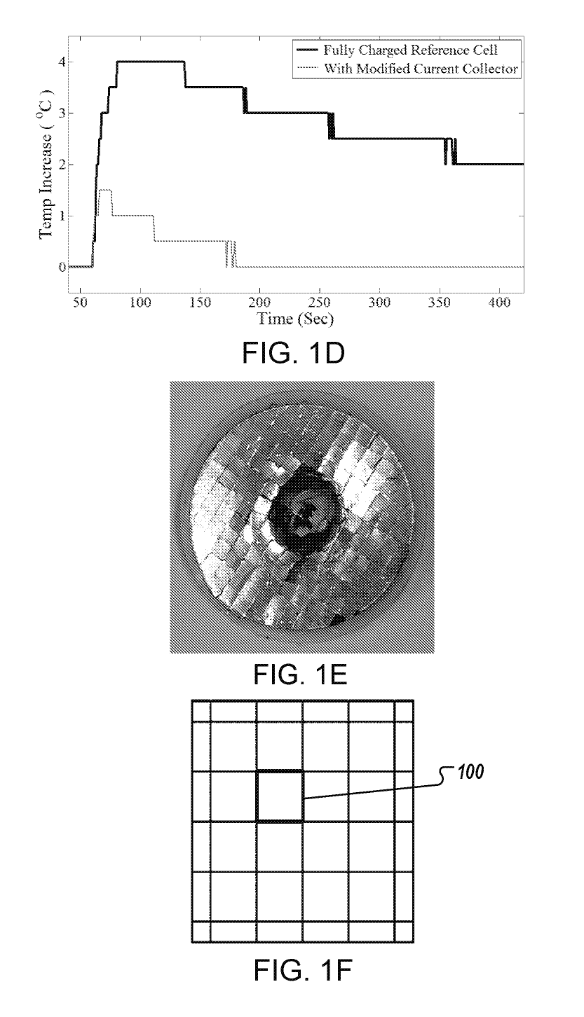

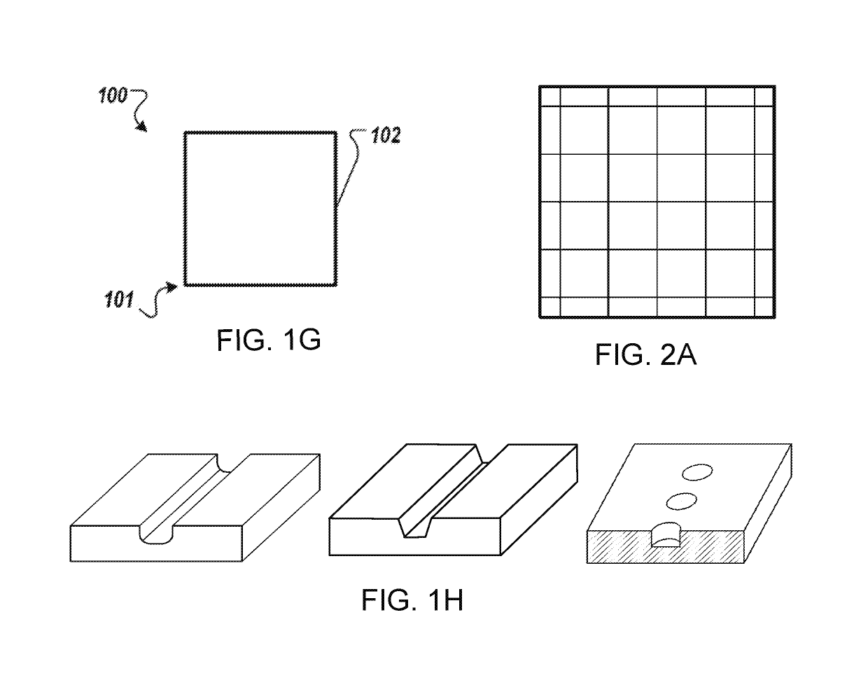

In one embodiment, we tested current collectors modified by locally anisotropic (e.g., having a shape that depends on direction)/heterogeneous (e.g., repeating same or similar properties) surface features. FIG. 1A shows the pattern of the surface features. The bottom surface of the current collector is smooth; the upper surface has two-dimensional square-wave-type features. FIG. 1B shows a schematic of the cross section of the surface features. The surface features were generated by etching an 18 μm thick aluminum sheet, as shown in FIG. 1C. Etching resist (KLT 6008 TRANSENE) was spin coated on the current collector at 5000 rpm for 30 sec. After masking (with photo masks from Fineline-image) and exposure to 3 mW LED UV light for 180 sec, the coated current collector was etched in an etchant at 50 oC for 15 min (Aluminum etchants type A, Transene). The depth of the surface features was around ¾ of the initial thickness of the aluminum sheet, and the width of the surface features was around 100 μm.

A circular piece was harvested from the modified aluminum sheet, with the diameter of about 9/16 inch. The circular piece was used as the current collector for the cathode in a battery coin cell. The mass ratio of active material (NCM; provided by TODA AMERICA, with the product number of NCM-04ST), carbon black (TIMCAL C-NERGY SUPER C65), and polyvinylidene fluoride (PVDF; provided by SIGMA-ALDRICH, with the product number of 182702-250G) was 93:3:4. The mass ratio of PVDF to NMP (provided by SIGMA-ALDRICH, with the product number of 328634) was 1:9. Slurry was mixed thoroughly by using a Qsonica Sonicator at a 100% power for 15 minute. The slurry was dried in a vacuum oven at 80 oC for 24 hours. The dried slurry thickness was around 100 μm and the active material mass on the current collector was about 35 mg. The slurry was compressed to the thickness of 80 μm by a Rolling Mill roller.

Type 2016 half-cell was assembled with a lithium disc as the anode. The lithium disc (provided by Tob New Energy Technology) thickness was 15.4 mm, and the diameter was 1.1 mm. Celgard-2320 trilayer Polypropylene-Polyethylene (PP/PE/PP) membrane was used as the separator between the cathode and the anode. The membrane thickness was 25 μm . About 30 μl BASF electrolyte (1M LiPF6 in 1:1 EC-EMC) was added into the battery cell. Altogether 3 nominally same half-cells were produced. They were charged to 4.6V by a MTI BST8-3 Battery Analyzer, with the charging rate of 0.1 C. To eliminate the influence of cell case, after being fully charged, the cell was reassembled by adding another layer of polyethylene film between the current collector and the cell case. The cover of cell case was modified, with a hollow opening in the middle.

Reference cells were prepared through a similar procedure, except that the reference current collectors were smooth 18 μm thick aluminum sheets without any modification.

Impact tests were performed by dropping a 7 kg cylindrical steel hammer onto the battery cell. The drop distance was 6 cm. A 4.8 mm diameter ceramic ball (the indenter) was placed at the center on the top of the cell case. The temperature-time history was measured by an Omega TT-K-40-25 type-K gage 40 thermal couple equipped with an Omega OM-EL-USB-TC temperature logger data acquisition system, with the record interval of 1 sec. The thermal couple tip was fixed by a duct tape on the top surface of the cell, about 4 mm away from the center. The cell and the thermocouple were thermally insulated by a ½ inch thick circular durometer 75 D polyurethane layer from the bottom and a 1 inch thick circular durometer 90 A polyurethane layer on the top. The bottom insulation layer had a ⅜ inch diameter circular hole in the middle. The cell was fixed in the bottom insulation layer by three layers of duct tapes.

The testing results are shown in FIG. 1D. The temperature profiles indicate that, with the locally anisotropic/heterogeneous features on the current collector, the peak temperature of the battery cell subjected to mechanical abuse is much reduced, compared with the reference cells. After the impact test, the damaged cell was opened and FIG. 1E shows that the modified current collector was completed broken apart along the surface features, separating the damaged internal shorting sites from the rest of the electrode. That is, the effective internal impedance is increased.

It should be noted that the geometry and pattern of the surface features of modified current collector are not limited to the ones shown this embodiment. The surface features on the current collector may contain a number of similar or identical or dissimilar elements 100 shown in FIG. 1F. The sizes, shapes, and orientations of the elements can vary in space. The shapes of the elements or surface features include but are not limited to connected or disconnected straight lines, curves, nodes or dots, triangles, circles, ovals, polygons, ellipses, squares, rectangles, trapezoids, polygons, crescents, crescents, stars, concave shapes, convex shapes, irregular shapes, or any combination of them.

The locally anisotropic/heterogeneous element may be viewed as an assembly of nodes 101 and paths 102, as shown in FIG. 1G. The path may comprise nodes, continuous lines, or discontinuous lines. The path may be straight or curved, intersected or separated; the spacing among the paths may be uniform or non-uniform. The shapes of nodes may include but are not limited to triangles, crescents, circles, ovals, polygons, ellipses, squares, rectangles, trapezoids, polygons, crescents, stars, concave shapes, convex shapes, irregular shapes, or any combination of them.

For all the modified current collectors in this document, the cross-sectional shapes of the locally anisotropic/heterogeneous surface features include but are not limited to slits, straight lines, curves, nodes or dots, triangles, circles, ovals, polygons, ellipses, squares, rectangles, trapezoids, polygons, crescents, stars, concave shapes, convex shapes, irregular shapes, convex-shaped, concave-shaped, crescents, or any combinations of them. The cross-sectional geometry and size may vary in space and the width and depth of the surface features may vary in space. The edges of the cross section can be straight or curved. Some examples of embodiment are shown in FIG. 1H. The surface features can be on one side or both sides of the current collector. The surface features on different sites and different locations of the current collector can be either the same, similar, or different.

### Example 2

### Current Collector Modified by Locally Anisotropic/Heterogeneous V-Shaped Surface Features

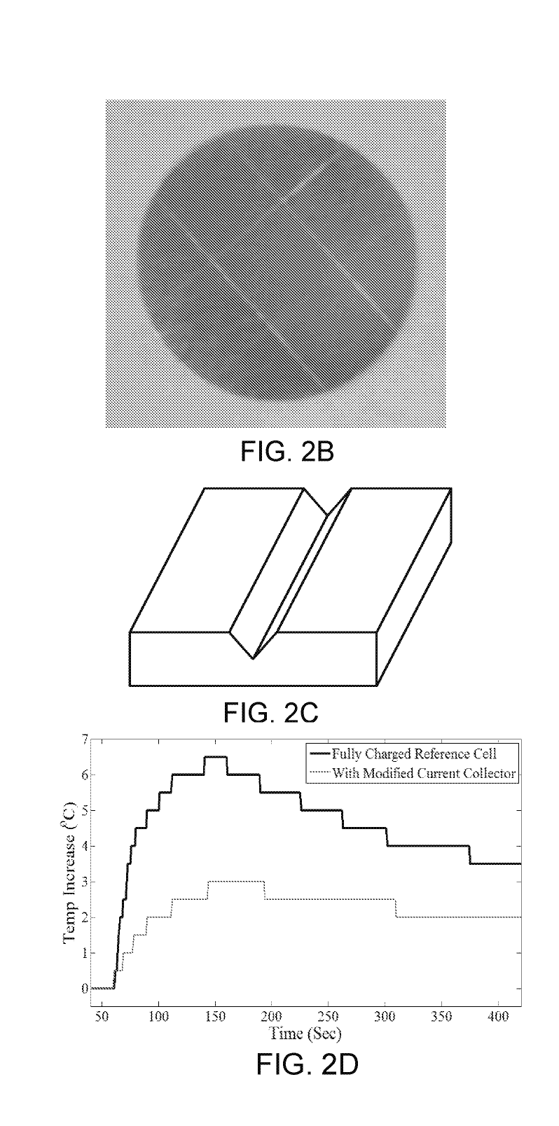

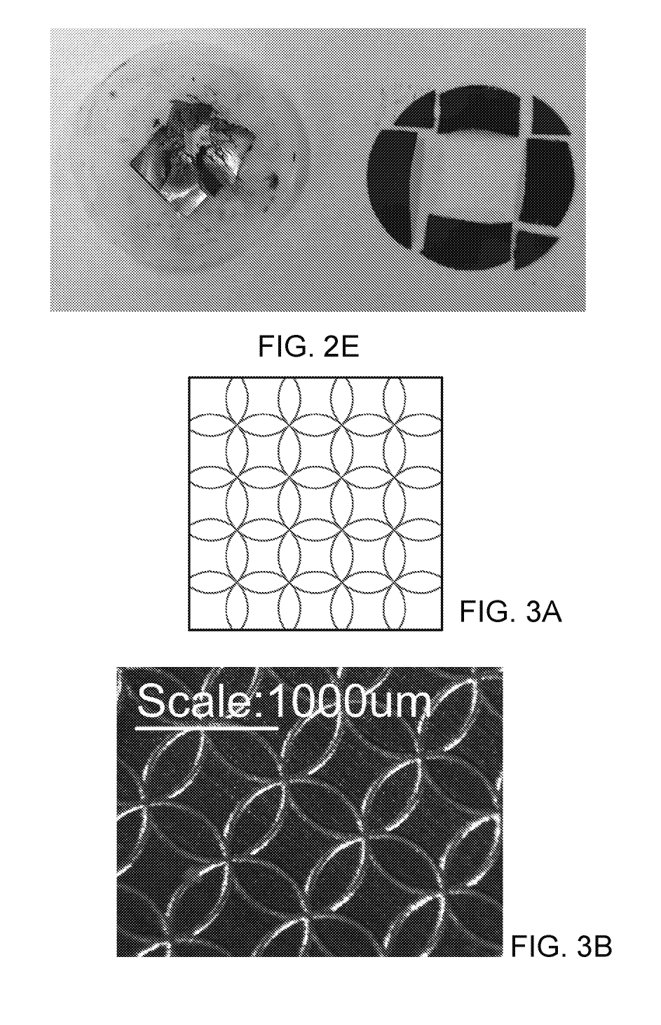

In one embodiment, we tested current collectors modified by locally anisotropic/heterogeneous V-shaped features. FIG. 2A shows a network formed by V-shaped features. On a smooth aluminum sheet with the initial thickness of 18 μm, V-shaped surface features were formed by pressing a No.11 scalpel blade by a constant force of 10 N into the aluminum, as shown in FIG. 2B. The depth of the V-shaped surface feature was nearly ⅔ of the initial aluminum sheet thickness. The radius of the root of the V-shaped feature was ˜2 μm, and the spacing between the adjacent V-shaped features was ¼ inch. FIG. 2C shows a schematic of the cross section of a V-shaped feature. Each line of the V-shaped feature may be viewed as a sharp-wave-shaped indentation.

A circular piece was harvested from the modified aluminum sheet, with the diameter of 9/16 inch. The circular piece was used as the current collector for the cathode in a battery coin cell. The mass ratio of active material (NCM; provided by TODA AMERICA, with the product number of NCM-04ST), carbon black (TIMCAL C-NERGY SUPER C65), and PVDF (provided by SIGMA-ALDRICH, with the product number of 182702-250G) was 93:3:4. The mass ratio of PVDF to NMP (provided by SIGMA-ALDRICH, with the product number of 328634) was 1:9. Slurry was mixed thoroughly by using a Qsonica Sonicator at a 100% power for 15 minute. The slurry was dried in a vacuum oven at 80 oC for 24 hours. The dried slurry thickness was around 100 μm and the active material mass on the current collector was about 35 mg. The slurry was compressed to about 80 μm by a Rolling Mill roller.

Type 2016 half-cell was assembled by using the cathode, together with a lithium disc as the anode, a PP/PE/PP membrane separator, 30 μl BASF electrolyte, and modified cell case, similar to that in Example 1. Altogether 3 nominally same half-cells were produced. They were charged to 4.6V by a MTI BST8-3 battery analyzer, with the charging rate of 0.1C. Reference cells were prepared through a similar procedure, except that the cathode current collectors were smooth 18 μm thick aluminum sheets without any modifications. Impact tests were conducted on the battery cells, similar to that in Example 1.

The testing results are shown in FIG. 2D. The temperature profiles indicate that, with the V-shaped features on the current collector, the peak temperature of the battery cell subjected to mechanical abuse is much reduced, compared with that of the reference cell. After the impact test, the damaged cell was opened and FIG. 2E shows that the modified current collector was broken apart along the V-shaped features, separating the damaged internal shorting sites from the rest of the electrode. Thus, the internal impedance is much increased.

### Example 3

### Current Collector Modified by Locally Anisotropic/Heterogeneous U-Shaped Surface Features

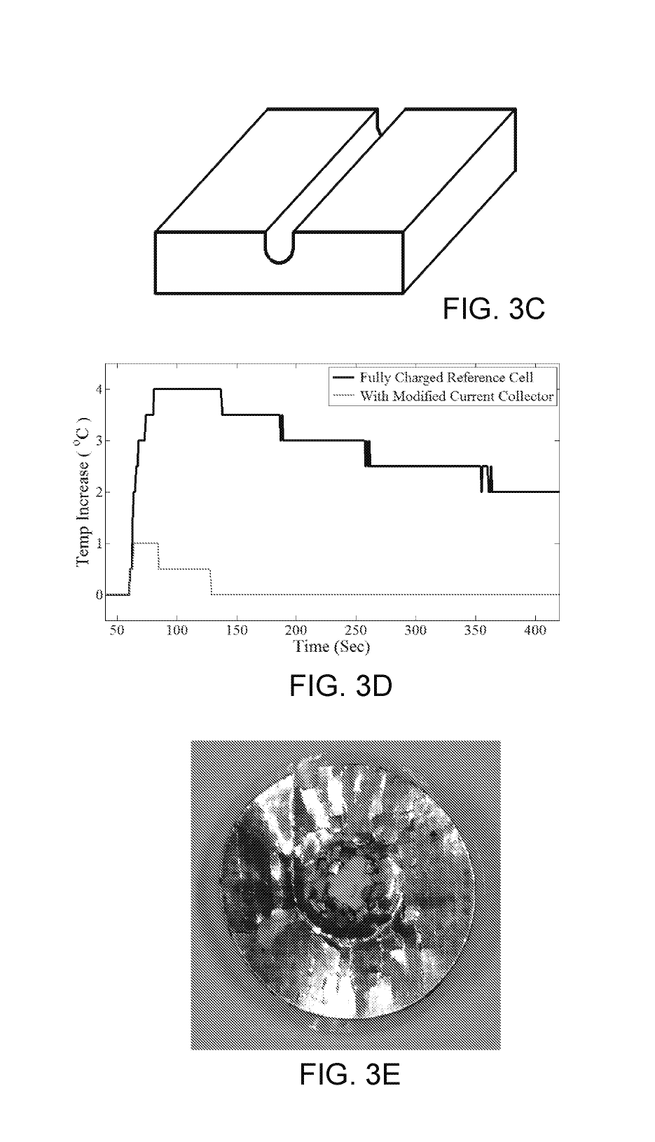

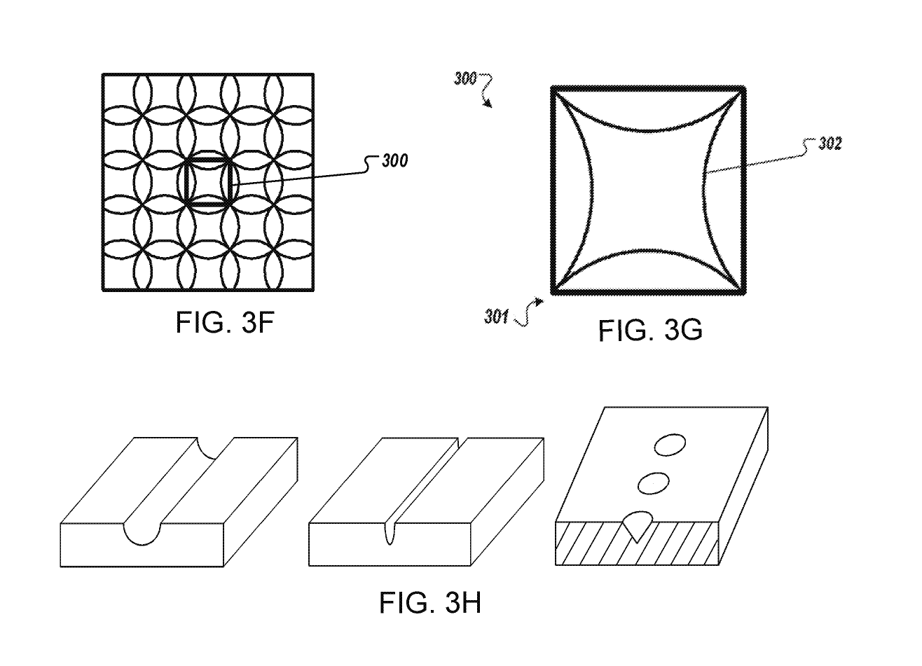

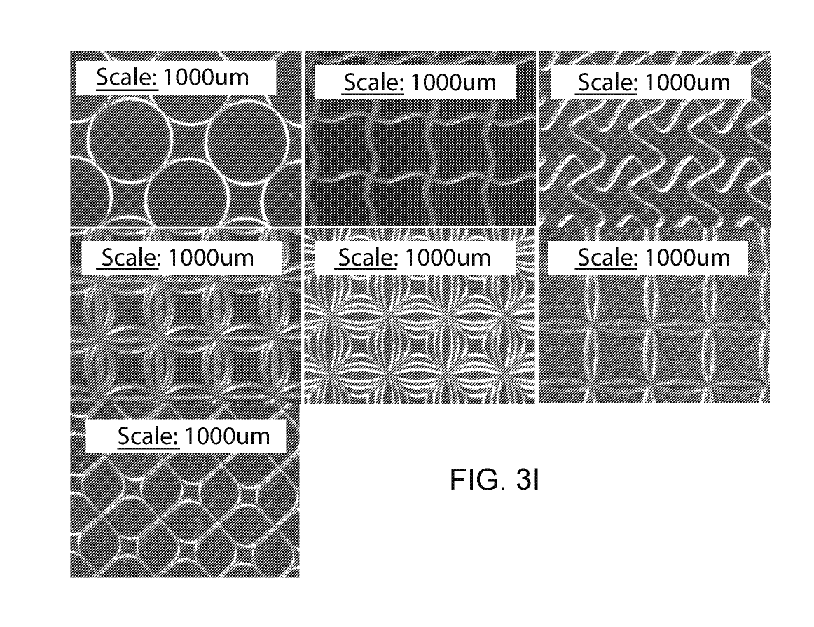

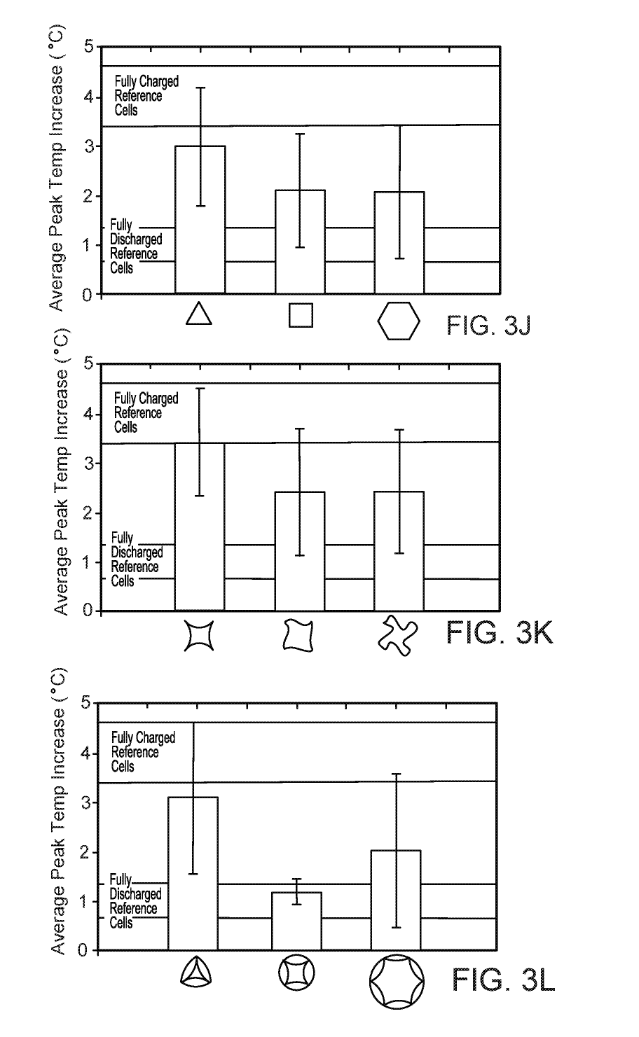

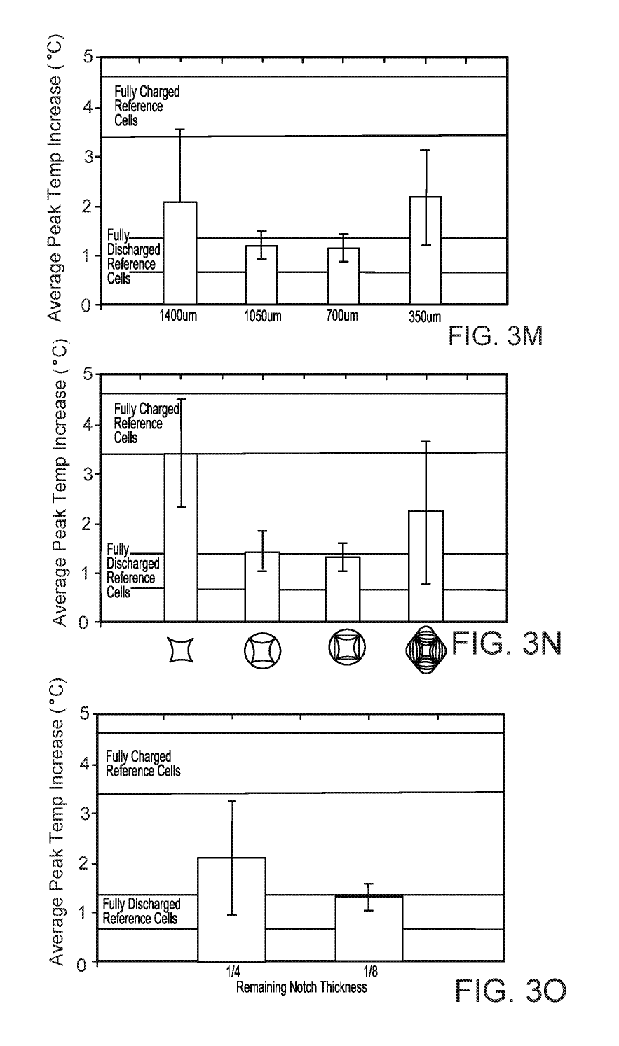

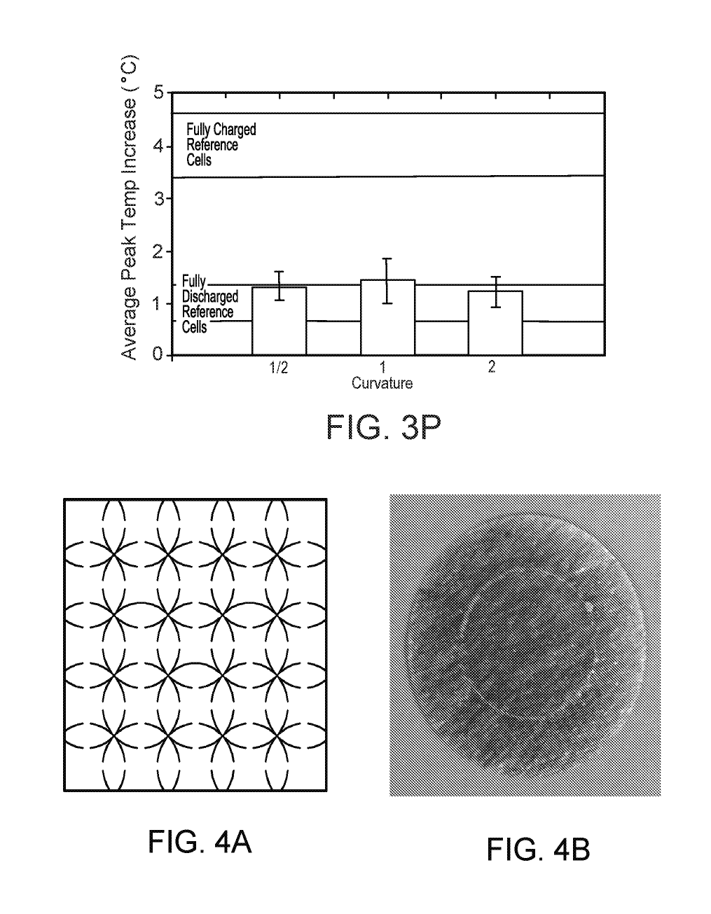

In another test, we tested current collectors modified by locally anisotropic/heterogeneous U-shaped surface features. FIG. 3A shows the pattern of the U-shaped features. The U-shaped features were formed by etching an 18 um thick aluminum sheet, as shown in FIG. 3B. Etching resist (KLT 6008 TRANSENE) was spin coated on the current collector at 5000 rpm for 30 sec. After masking (with photo masks from Fineline-image) and exposure to 3 mW LED UV light for 180 sec, the coated current collector was etched in an etchant at 50° C. for 15 min (Aluminum etchants type A, Transene). The depth of the U-shaped feature was around ⅔ of the initial thickness of aluminum sheet; the width of the U-shaped features was around 20 μm; the radius of the root of the U-shaped feature was around 14 μm; the diameter of each circle of the U-shaped features was 1 mm. FIG. 3C shows a schematic of the cross section of a U-shaped surface feature; it may be viewed as a U-wave-shaped indentation in the current collector. The modified current collectors were used to produce battery cells, and the battery cells were tested in impact experiments. The cell processing and the impact testing procedures were similar with that of the current collectors modified by V-shaped surface features.

The testing results are shown in FIG. 3D. The temperature profiles indicate that, with the U-shaped features modified current collector, the peak temperature of the battery cell subjected to mechanical abuse is much reduced, compared with that of the reference cell. After the impact test, the damaged cell was opened and FIG. 3E shows that the current collector was broken apart along U-shaped features, separating the damaged internal shorting sites from the rest of the electrode.

It should be noted that the design of the surface features of the current collector is not limited to what are shown in this embodiment. The pattern of the surface features may comprise a number of elements 300, as shown in FIG. 3F; the sizes, shapes, and orientations of the elements can vary in space. The shapes of the elements or surface features include but are not limited to connected or disconnected straight lines, curves, nodes, triangle, square, rectangle, trapezoid, polygon, circle, ellipse, and irregular shapes, or any combination of them.

Each element may comprise nodes 301 and paths 302, as shown in FIG. 3G. The path may comprise dots, nodes, or continuous or discontinuous lines. The path may be straight and/or curved, intersected and/or separated; the spacing of the paths may be uniform or non-uniform.

The cross-sectional shapes of the locally anisotropic/heterogeneous features include but are not limited to slits, straight lines, curves, nodes or dots, triangles, circles, ovals, polygons, ellipses, squares, rectangles, trapezoids, polygons, crescents, crescents, stars, concave shapes, convex shapes, irregular shapes, or any combination of them. The cross-sectional geometry, size, and orientation may vary in space; the width and depth of the surface features may vary in space. The edges of the cross sections of the surface features can be straight or curved. Some examples are shown in FIG. 3H.

FIG. 3I shows the microscopic photos of a few examples of patterns of surface features. Parameterized studies were conducted to analysis the effects of surface-feature geometry on thermal runaway in impact tests. In one set of tests, the node distribution effects on the average peak temperature increase were tested. The Inter-nodal distance was 700 μm; the path depth was ¾ of the original current collector thickness, and the path width was ˜100 μm. The testing results are shown in FIG. 3J. In another set of tests, the path shape effects on the average peak temperature increase were tested. The inter-nodal distance was 700 μm; the path depth was ¾ of the original current collector thickness, and the path width was ˜20 μm. The testing results are shown in FIG. 3K and FIG. 3L. In yet another set of tests, the inter-nodal distance effects on the average peak temperature increase were tested. The surface feature patterns are shown in FIG. 3A; the path depth was ¾ of the original current collector thickness; and the path width was ˜20 μm. The testing results are shown in FIG. 3M. In yet another set of tests, the path number effects on the average peak temperature increase were tested. The inter-nodal distance was 700 μm; the path depth was ¾ of the original current collector thickness; and the path width was ˜20 μm. The testing results are shown in FIG. 3N. In yet another set of tests, the path depth effects on the average peak temperature increase were tested. The surface-feature pattern is shown in FIG. 2A. The inter-nodal distance was 700 μm, and the path width was ˜20 μm. The testing results are shown in FIG. 3O. In yet another set of tests, the path curvature effects on the average peak temperature increase were tested. The surface-feature pattern is shown in FIG. 3A. The inter-nodal distance was 700 μm, and the path width was ˜20 μm. The testing results are shown in FIG. 3P.

### Example 4

### Current Collector Modified by Precracks

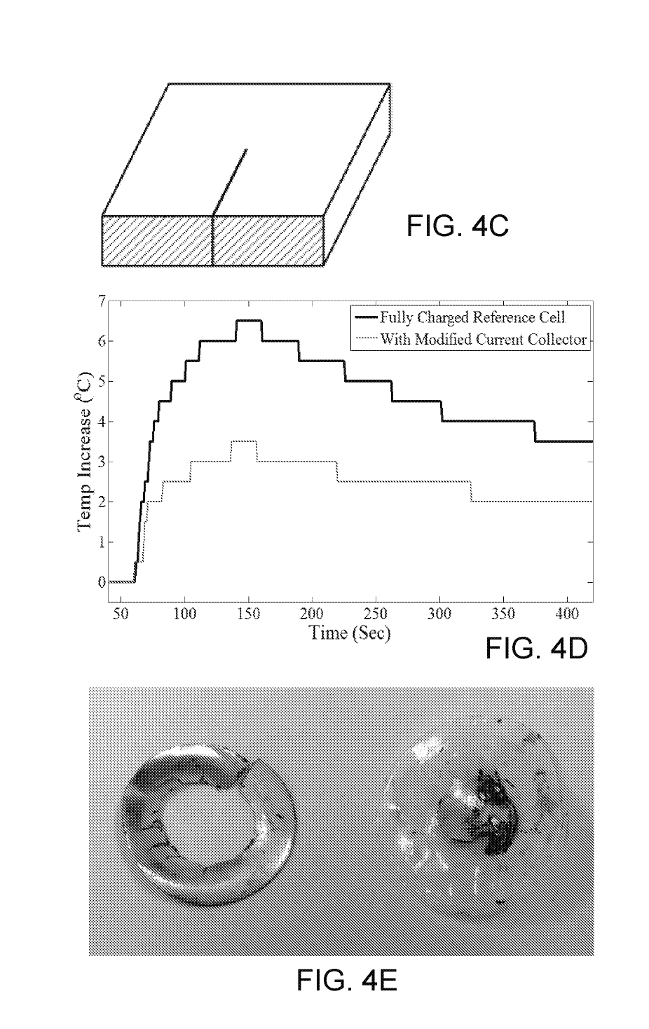

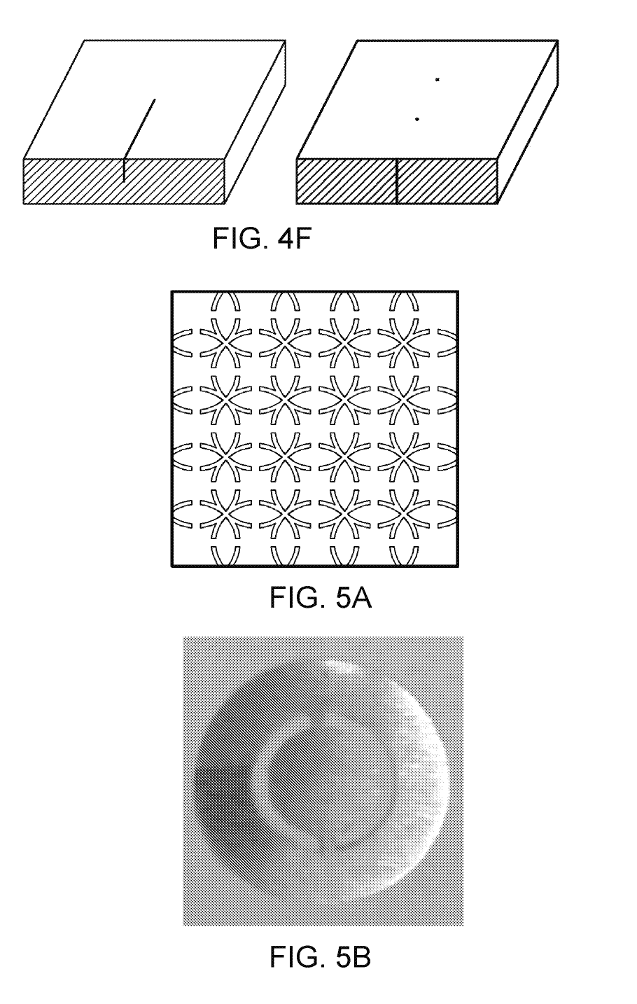

In one embodiment, we tested current collectors modified by precracks. FIG. 4A depicts a network of precracks. On a smooth aluminum sheet with the initial thickness of 18 μm, precracks were formed by using a steel ring cutter with broken blade; the broken parts lead to the connection ligaments between the precracks, as shown in FIG. 4B. The spacing between adjacent precracks was 1/25 inch. FIG. 4C shows the cross section of a precrack.

A circular piece was harvested from the precracked aluminum sheet, with the diameter of 9/16 in. The circular piece was used as the current collector for the cathode in a battery coin cell. The processing and testing procedures of the battery cell were similar to that in Example 1.

The results of the impact tests are shown in FIG. 4D. The temperature profiles indicate that, with the precracks on the current collector, the peak temperature of the battery cell subjected to mechanical abuse is much reduced, compared with that of the reference cells. After the impact test, the damaged cell was opened and FIG. 4E shows that the modified current collector was broken apart along the precracks, separating the damaged internal shorting sites from the rest of the electrode.

It should be noted that the design is not limited to what are shown in this embodiment. The pattern of the precracks may comprise a number of elements; the sizes, shapes, and orientations of the elements can vary in space. The shapes of the elements, precracks, or cross sections of precracks include but are not limited to connected or disconnected straight lines, curves, nodes or dots, triangles, circles, ovals, polygons, ellipses, squares, rectangles, trapezoids, polygons, crescents, crescents, stars, concave shapes, convex shapes, irregular shapes, or any combination of them.

Each element may comprise nodes and paths. A path may comprise dots, nodes, or lines. The path may be straight or curved, intersected or separated; the spacing among the paths may be uniform or non-uniform. The cross-sectional geometry and size of precrack may vary in space; the width, depth, and orientation of precrack may vary in space. Some examples of embodiment are shown in FIG. 4F.

### Example 5

### Current Collector Modified by Stress-Concentrating Vacancies

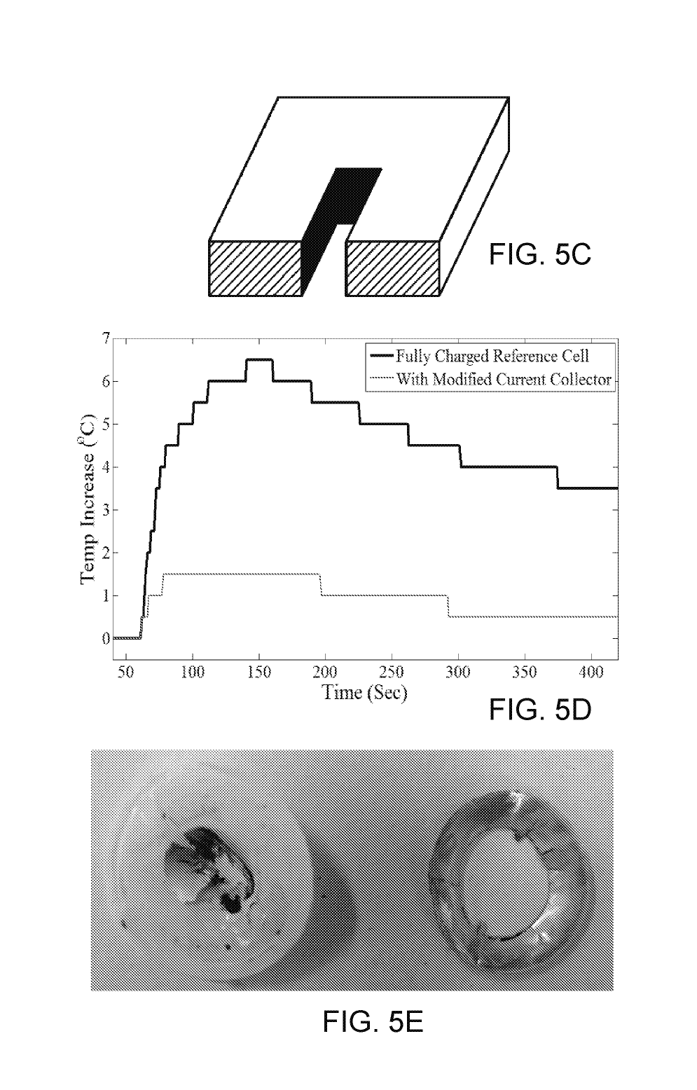

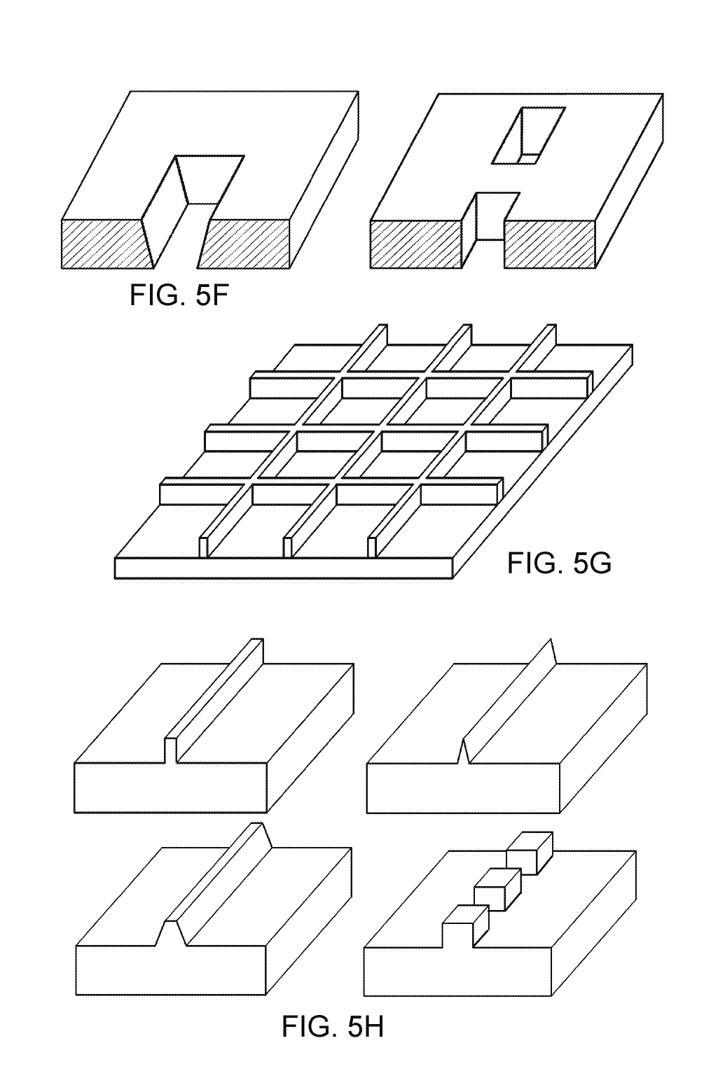

In one embodiment, we tested current collectors with stress-concentrating vacancies (SCV). FIG. 5A depicts a network of SCV. On a smooth aluminum sheet with the initial thickness of 18 μm, SCV were formed by punching a curved cutter through the aluminum sheet. The inner and outer diameters of SCV were ¼ inch and 5/16 inch, respectively, as shown in FIG. 5B. FIG. 5C shows a schematic of the cross section of a SCV.

A circular piece was harvested from the aluminum sheet modified by SCV, with the diameter of 9/16 in. The circular piece was used as the current collector for the cathode in a battery coin cell. The processing and testing procedures of the coin cells were similar to that in Example 1.

The results of the impact tests are shown in FIG. 5D. The temperature profiles indicate that, with the current collector modified by SCV, the peak temperature of the battery cell subjected to mechanical abuse is much reduced, compared with that of the reference cell. After the impact test, the damaged cell was opened and FIG. 5E shows that the current collector was broken apart along the SCV, separating the damaged internal shorting sites from the rest of the electrode.

It should be noted that the design of SCV is not limited to what are shown in this embodiment. The sizes, shapes, and orientations of the element or the SCV can vary in space. The edges of SCV include connected or disconnected straight lines, curves, or nodes. The shapes of the elements or the SCV include but are not limited to slits, slots, straight lines, curves, nodes or dots, triangles, circles, ovals, polygons, ellipses, squares, rectangles, trapezoids, polygons, crescents, crescents, stars, concave shapes, convex shapes, irregular shapes, or any combination of them.

The SCV pattern may comprise nodes and paths. The path may comprise nodes or continuous or discontinuous lines. The path may be straight or curved, intersected or separated; the spacing among the paths may be uniform or non-uniform.

The cross-sectional shapes of stress concentration vacancies include but are not limited to slits, slots, straight lines, curves, nodes or dots, triangles, circles, ovals, polygons, ellipses, squares, rectangles, trapezoids, polygons, crescents, crescents, stars, concave shapes, convex shapes, irregular shapes, or any combination of them. The cross-sectional geometry and size may vary in space, and the width and depth of SCV may vary in space. The edges of SCV cross sections can be straight lines or curves. Some examples are shown in FIG. 5F.

The stress-concentrating surface features can be protruding. FIG. 5G shows a design of locally anisotropic/heterogeneous protruding surface features (PSF). It should be noted that the design is not limited to what are shown in this embodiment. The material of locally anisotropic/heterogeneous PSF can be identical or different from the current collector material. The materials of PSF can be metals, alloys, ceramics, polymers, glasses, carbons, elastomers, or any combination of them. The PSF may be viewed as protruding waves on the surfaces of current collectors. The PSF can be on one side or both sides of the current collector.

The pattern of PSF may comprise elements. The sizes, shapes, and orientations of the elements can vary in space. The shapes of the elements or PSF include but are not limited to connected or disconnected straight lines, curves, nodes or dots, triangles, circles, ovals, polygons, ellipses, squares, rectangles, trapezoids, polygons, crescents, crescents, stars, concave shapes, convex shapes, irregular shapes, or any combination of them.

The element may comprise nodes and paths. The path may comprise nodes or discontinuous or continuous lines. The path may be straight or curved, intersected or separated; the spacing among the paths may be uniform or non-uniform.

The cross-sectional shapes of the locally anisotropic/heterogeneous PSF include but are not limited to straight lines, curves, nodes or dots, triangles, circles, ovals, polygons, ellipses, squares, rectangles, trapezoids, polygons, crescents, crescents, stars, concave shapes, convex shapes, irregular shapes, or any combination of them. The cross-sectional geometry, size, and orientation of PSF may vary in space; the width and depth of PSF may vary in space. The edges of the cross section of PSF can be straight or curved. Some examples are shown in FIG. 5H.

### Example 6

### Current Collector with Mechanically-Triggered Glass Components

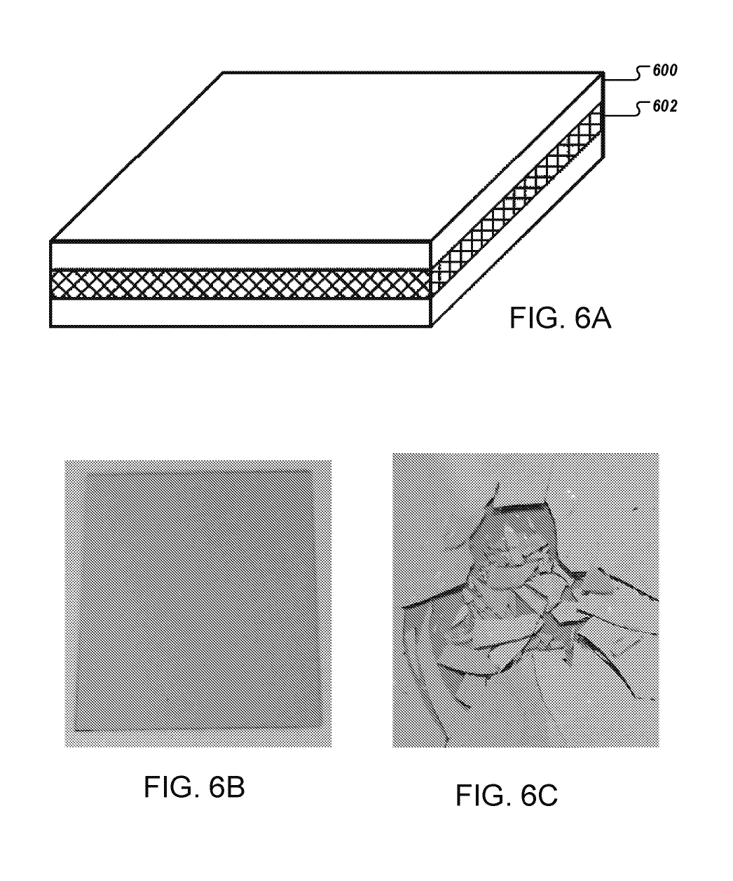

In one embodiment, we tested current collectors with mechanically-triggered components. FIG. 6A shows a current collector 600 modified by mechanically-triggered glass components 602. A photo of such a current collector is shown in FIG. 6B. The size of the current collector was 25 mm by 25 mm. The current collector was made by coating a 150 nm thick aluminum layer onto a 200 μm thick glass film using a Denton Discovery 18 System. The resistivity was measured by a B&K Precision 2405 A multimeter with a distance of probes of 5 mm. Before the impact test, the average resistivity was 2.1 Ω per 5 mm. Impact tests were performed on the current collector, by dropping a 7 kg cylindrical steel hammer at a distance of 20 mm. FIG. 6C shows that the current collector was broken apart after the impact test. The resistivity over a distance of 5 mm of the broken, impacted current collector was beyond the upper limit of the measurement device.

### Example 7

### Current Collector with Mechanically-Triggered Polymer Components

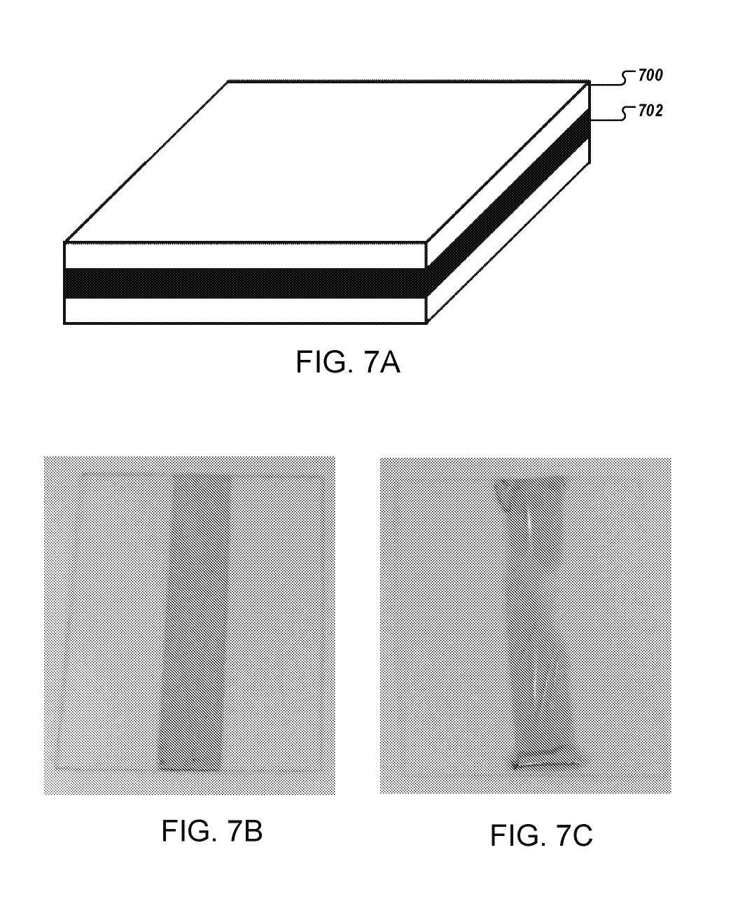

In one embodiment, we tested current collectors with mechanically-triggered polymer components. FIG. 7A shows a current collector 700 modified by a mechanical-trigger polymer layer 702. A photo of such a current collector is shown in FIG. 7B. The size of the current collector was 5 mm by 25 mm. The current collector was made by coating a 150 nm thick aluminum layer onto a 10 μm thick polyethylene film using a Denton Discovery 18 Sputtering System. The resistivity was measured by a B&K Precision, 2405 A multimeter with the distance of probes of 5 mm. Before mechanical testing, the average resistivity was 2.4 Ω per 5 mm. The current collector was stretched by 10% by an Instron 5582 machine. FIG. 7C shows that the current collector was broken. The resistivity over a distance of 5 mm of the broken, deformed current collector was beyond the upper limit of the measurement device.

It should be noted that the design of the mechanically-triggered components is not limited to what are shown in the above two embodiments. The materials of the mechanically-triggered component can be metals, alloys, ceramics, polymers, glasses, carbons, elastomers, or any combination of them. The thickness of the mechanically-triggered components can vary in space; they may be thicker or thinner than of the components current collector. The mechanically-triggered components can occupy a portion or the entire volume of the current collector. The distribution of the mechanically-triggered components can be continues or discontinues, heterogeneous or homogeneous, isotropic or anisotropic, uniform or non-uniform in space. The mechanically-triggered components can comprise multiple components with same or different triggering mechanisms. The mechanically-triggered components can be mixed with, next to, adjacent to, beneath, on top of, or between the components of current collector.

### Example 8

### Current Collector with Thermally or Mechanically Triggered, Locally Anisotropic/Heterogeneous Dissimilar Components

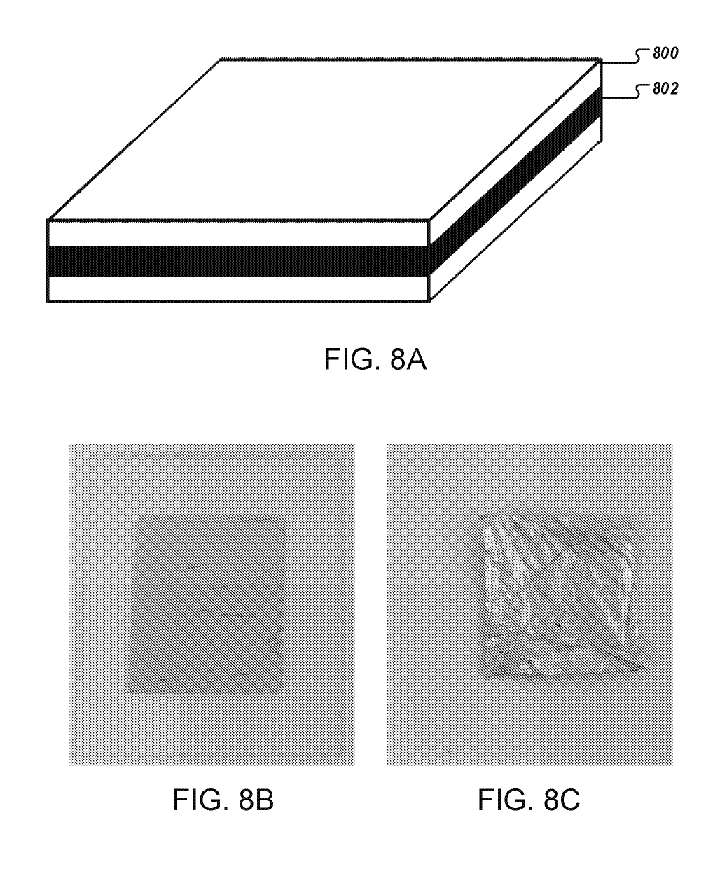

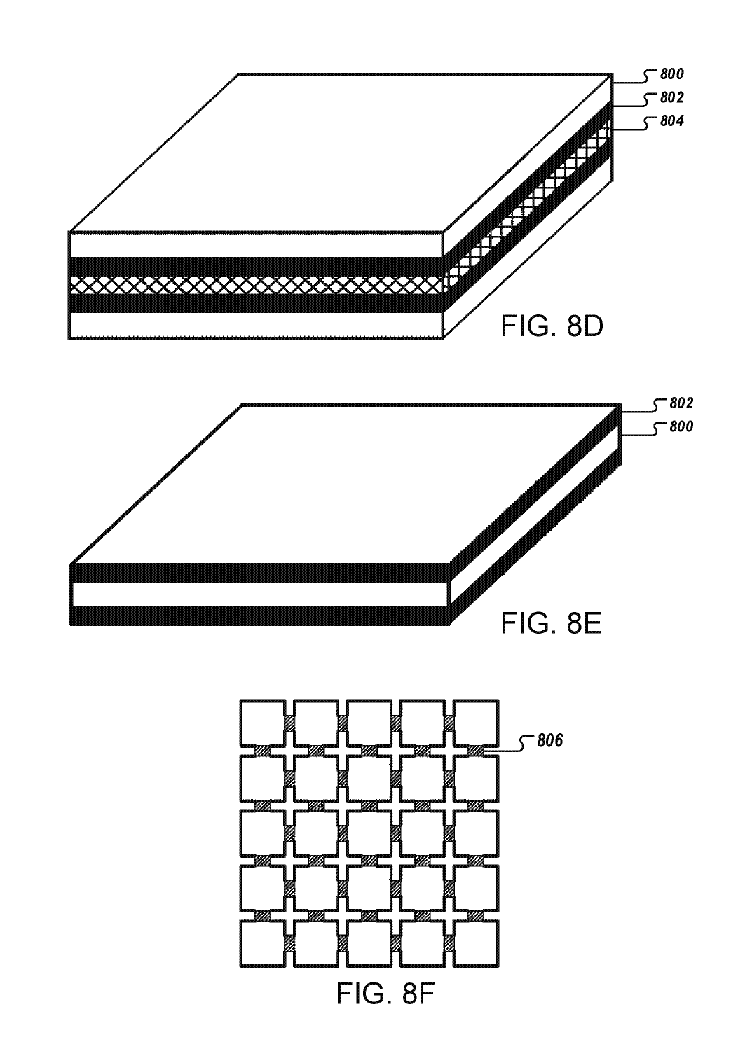

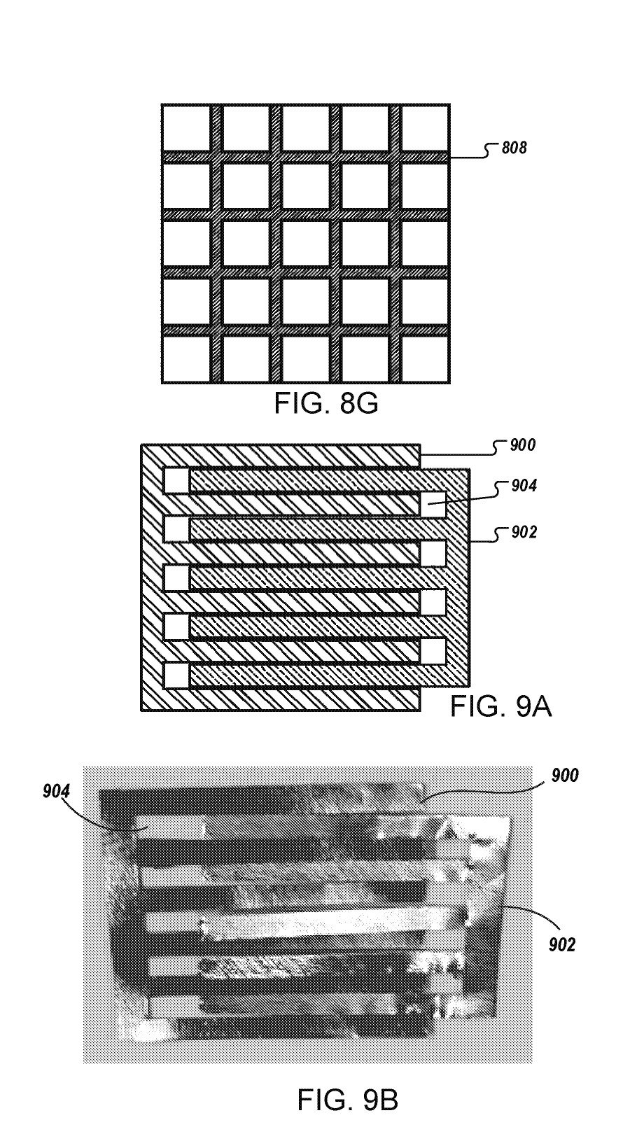

In one embodiment, we tested current collectors with thermally triggered components. FIG. 8A shows a current collector 800 modified by a thermally triggered component 802. A photo of such a sample is shown in FIG. 8B. The size of the current collector was 13 mm by 13 mm. The current collector was made by coating a 150 nm thick aluminum layer onto a 10 μm thick polyethylene film, by using a Denton Discovery 18 Sputtering System. The resistivity was measured by a B&K Precision 2405 A multimeter with the distance of probes of 5 mm. Before thermal testing, the average resistivity was 2.4 Ω per 5 mm. The current collector was heated up to 120 ° C. After the thermal test, the sample was shown in FIG. 8C; it was clearly damaged. The average resistivity measured increased to 145 Ω per 5 rnm, indicating that the impedance became higher, due to the deformation upon the thermal abuse.

It should be noted that the design of thermally-triggered components is not limited to what are shown in this embodiment. The materials of the thermally-triggered components can be metals, alloys, ceramics, polymers, glasses, carbons, elastomers, or any combination of them. The size of a thermally-triggered component can vary, so that it may be thicker or thinner than the component of current collector. The thermally triggered components can occupy a portion or the entire volume of the current collector. The distribution of the thermally triggered components can be continues or discontinues, heterogeneous or homogeneous, isotropic or anisotropic, uniform or non-uniform in space. The thermally triggered components can compose of multiple parts, with same or different triggering mechanisms, as shown in FIG. 8D, which has a current collector 800 with thermally triggered 802 components and mechanically triggered components 804. The thermally triggered components 802 can be beneath, on top of, next to, adjacent to, or mixed with the components of current collector 800, one example of which is shown in FIG. 8E.

The current collector can comprise locally anisotropic/heterogeneous dissimilar components. FIG. 8F and FIG. 8G show two examples of current collectors containing triggering components 806 and 808. The triggering components may deform or break upon thermal or mechanical abuse, so as to increase the internal impedance. The materials of the locally anisotropic/heterogeneous dissimilar components can be metals, alloys, ceramics, polymers, glasses, carbons, elastomers, or any combination of them. The form of the locally anisotropic/heterogeneous dissimilar components can be particles, dots, nodes, rods, bars, layers, layer stacks, blocks, strips, laminates, or any combination of them. The geometry of the components can vary in space, including but not limited to joints, bridges, islands, belts, ribbons, sleeves, connectors, dots, particles, plates, films, membranes, fibers, blocks, rods, tubes, or any combination of them. The distribution of the components can be homogeneous or heterogeneous, isotropic or anisotropic, uniform or non-uniform in space. Their distribution pattern can be straight, circular, curved, wavy, kinked, zigzag-shaped, bent, or randomly located dots, lines, areas, volumes, or any combination of them. The components can be based on a single or multiple triggering mechanisms. The concepts shown in previous embodiments can be used as or combined into the dissimilar components.

### Example 9

### Locally Anisotropic/Heterogeneous Stack of Current Collectors

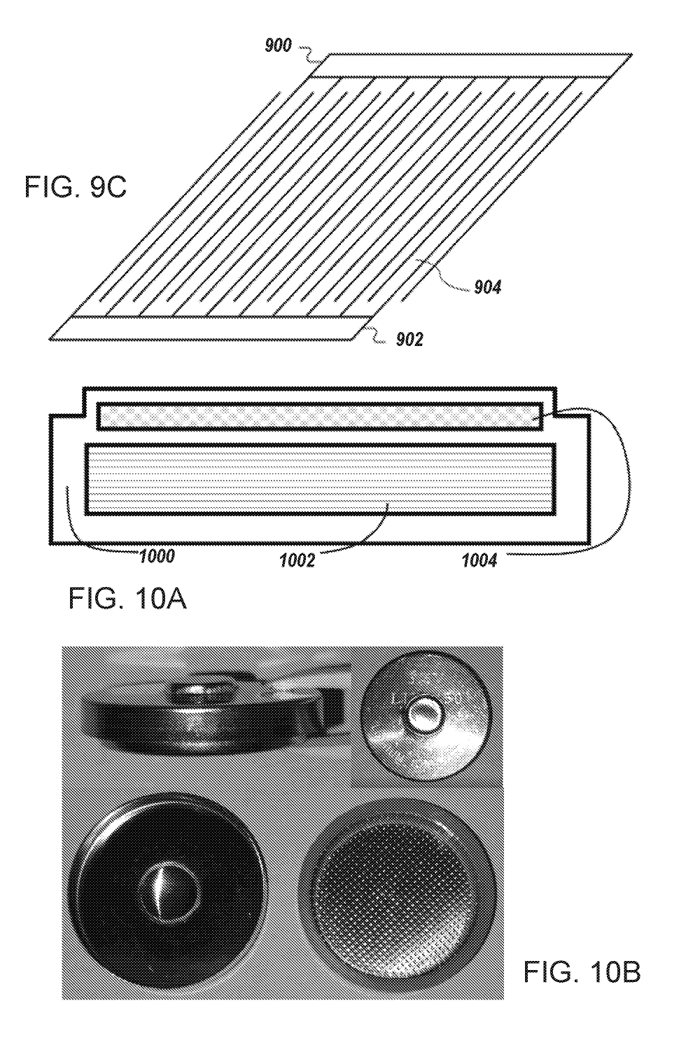

In one embodiment, the anode and cathode current collectors were modified and stacked in a mismatched manner. FIG. 9A shows an example of alternately mismatched cathode and anode current collectors, and FIG. 9B shows a photo. The current collector consists of current collecting components 904 and 902 separated by non-current-collecting (NCC) components 904; in FIG. 9A and FIG. 9B, the NCC components are empty gaps between the strips of current collecting components. In the top view, it can be seen that the CC components of the anode and the cathode current collectors do not overlap with each other. With such as locally anisotropic/heterogeneous, mismatched arrangement, when the battery cell is subjected to a mechanical loading, the current collecting components of the current collectors of anode and cathode may not be in directly contact with each other, and therefore, the internal impedance is relatively high and the internal shorting effects are mitigated.

The shape of the NCC components includes but is not limited to connected or disconnected straight lines, curves, nodes or dots, triangles, circles, ovals, polygons, ellipses, squares, rectangles, trapezoids, polygons, crescents, crescents, stars, concave shapes, convex shapes, irregular shapes, or any combination of them. The cross-sectional shapes of vacancies include but are not limited to straight lines, curves, nodes or dots, triangles, circles, ovals, polygons, ellipses, squares, rectangles, trapezoids, polygons, crescents, crescents, stars, concave shapes, convex shapes, irregular shapes, or any combination of them. The cross-sectional geometry and size may vary in space, and the width and depth may vary in space. The edges of the cross sections of the NCC components can be straight or curved. The materials of the NCC components include but are not limited to vacuum, gas, solid, or liquid materials, such as air, non-conductive liquids, high-resistance metals and alloys, ceramics, polymers, elastomers, glasses, carbons, etc., or any combination of them. The patterns of the cathode and anode current collectors can also be parallel fibers, strips, such as the example shown in FIG. 9C.

### Example 10

### Mechanically/Thermally Triggered Cell Cases 1000 and Cell Case Components (Electrode Stack 1002 and Thermal Retarding and/or Flame Retarding Additive 1004) Structured with Thermal-Runaway-Mitigating and Fire-Mitigating Materials

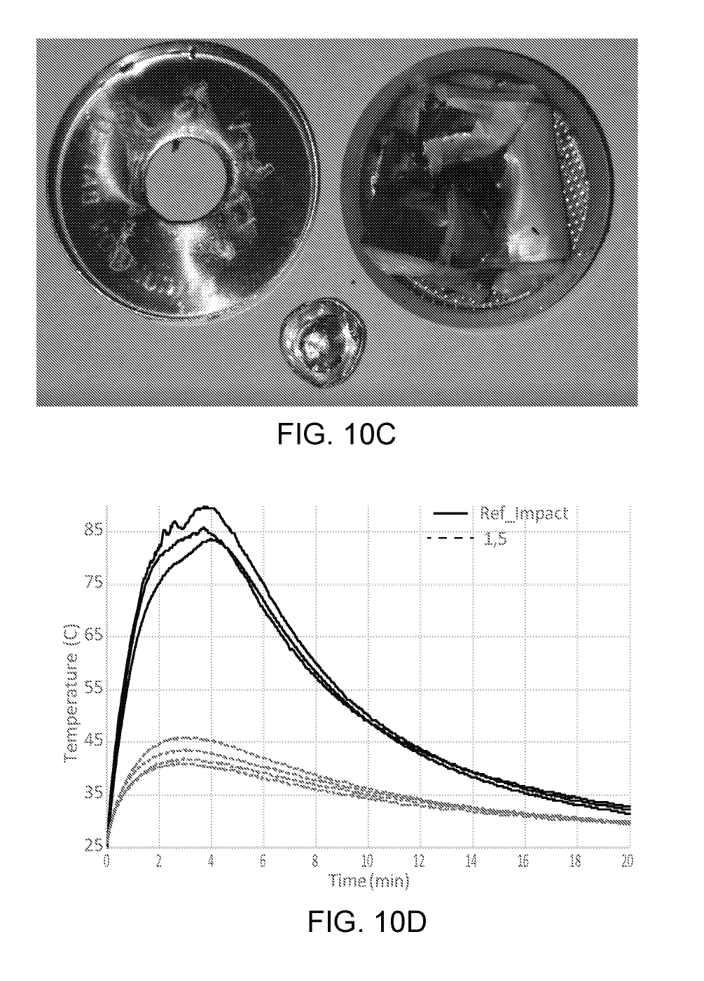

In one embodiment, we employed mechanically triggered, thermally triggered, or both mechanically and thermally triggered single-component or multi-component cell cases structured with one or multiple thermal runaway mitigating materials or components, fire mitigating materials, or both thermal runaway and fire mitigating materials. The setup shown in FIG. 10A depicts a cross section of one such cell case structure design. We tested one such multicomponent, mechanically triggered cell case structured with thermal runaway mitigating material using a multilayered lithium-ion battery cell with a modified LIR2450 type cell case, where a mechanically triggered aluminum pouch component containing 1,5-pentanediol additive was incorporated into the stainless steel bottom shell component of the structure, as shown in FIG. 10B.

The cell case was constructed by modifying a 304 stainless steel CR2450 cell case with seal O-ring (provided by AA Portable Power Corp, part #24500R304-1). The mechanically triggered aluminum pouch component was made using a standard direct scanning calorimetry 50 μL capacity sample pan and cover (provided by Perkin Elmer part #02190041). The pan was filled with 33 μL of 1,5-pentanediol (provided by Sigma Aldrich, SKU #76892) and sealed with the cover using a standard sample pan crimping press (provided by Perkin Elmer part #02190048). A 9/32″ diameter hole was removed from the center of the bottom shell component using a hand punch and the mechanically triggered additive containing pouch component was pressed into the hole forming a physical seal, completing construction of the additive modified cell case.

The battery cell was assembled using a LiCoO₂/C multilayered electrode stack (including cathode, anode, charge collectors, separator, and electrolyte) harvested from a commercially available LIR2450 cell (3.6 V, 120 mAh, 0.43 Wh) (provided by AA Portable Power Corp, part #LIR2450) sealed in the modified battery cell case. The commercially available battery cells were charged by a constant current—constant voltage algorithm (C/12→C/150) to 4.2 V using a battery analyzer (provided by MTI, item #BST8-3). The fully charged cell was then disassembled and the multilayered electrode stack was removed using a crimping and disassembling press with a CR2450 disassembling die set (provided by MTI, item #MSK110D-DS2450). The harvested electrode stack was then placed in the additive-modified cell case and tightly sealed with polyimide tape, completing assembly of the modified battery cell.

Reference battery cells were prepared through a similar procedure, except that no thermal runaway mitigating material (e.g. 1,5-pentanediol additive) was included in the mechanically triggered aluminum pouch component; i.e. the pouch was empty.

Impact tests were performed on both reference cells and modified cells. A 7 kg cylindrical steel hammer was dropped from a distance of 30 cm onto a ¼″ diameter brass ball indenter that had been suspended 5 mm above the mechanically triggered aluminum pouch component. Temperature response was measured with a type-K gage 40 thermocouple (provided by Omega, part #TT-K-40-25) equipped with a temperature logging data acquisition system (provided by Omega, part #OM-EL-USB-TC), with a recording interval of 1 second. The thermocouple tip was affixed to the stainless steel bottom shell component with polyimide tape, 5 mm away from the outer diameter of the mechanically triggered aluminum pouch component of the structure. The battery cell was affixed to a ½″ thick circular polyurethane base using masking tape prior to the impact.

An image depicting the damage sustained upon impact is shown in FIG. 10C and the temperature response testing results are shown in FIG. 10D. The temperature profiles and the images indicate that by using a mechanically triggered battery cell case with thermal runaway mitigating materials incorporated into its structure, heat generation and accrued temperature due to mechanical abuse can be significantly reduced or retarded. It is also representative of how fire mitigating materials could be incorporated into a mechanically triggered single or multicomponent cell case structure to reduce, prevent, retard, or extinguish a fire due to mechanical abuse. Additionally, similar designs for thermally triggered cell cases and cell case components structured with thermal runaway mitigating or fire mitigating materials may serve to reduce or retard heat generation or accrued temperature or reduce, prevent, retard, or extinguish a fire due to thermal abuse, or reduce the flammability of battery components such as electrolyte.

The cell case may be a single or multicomponent structure with one or multiple cavities or voids in one or multiple locations within the structure which may contain one or multiple thermal runaway mitigating materials, fire mitigating materials, or both thermal runaway and fire mitigating materials. The cell case structure may also or alternatively comprise one or multiple thermal runaway mitigating material containing components, fire mitigating material containing components, or both thermal runaway and fire mitigating material containing components, arranged in one or multiple locations attached to, affixed to, or incorporated into anywhere above, below, adjacent, outside, inside, or within the case structure. Additionally, the cell case structure may also comprise one or multiple components which do not contain thermal runaway mitigating nor fire mitigating materials arranged in one or multiple locations attached to, affixed to, or incorporated into anywhere above, below, adjacent, outside, inside, or within the case structure.

Mechanically triggered, thermally triggered, or both mechanically and thermally triggered cell cases and cell case components may be made up of one or multiple geometries, orientations, surface features, and materials.

The thermal runaway mitigating or fire mitigating material or additive contained in such a case structure or case structure component may include any and all functional solids, liquids, gases, solutions, suspensions, emulsions, foams, gels, plasmas, or combinations of, which serve to mitigate heat generation or accrued temperature or prevent, retard, or extinguish a fire in response to mechanically or thermally abusive event, or reduce the flammability of battery components such as electrolyte.

### Example 11

### Mechanically and Thermally Triggered Cell Case and Cell Case Component Geometries, Orientations, Surface Features, and Materials

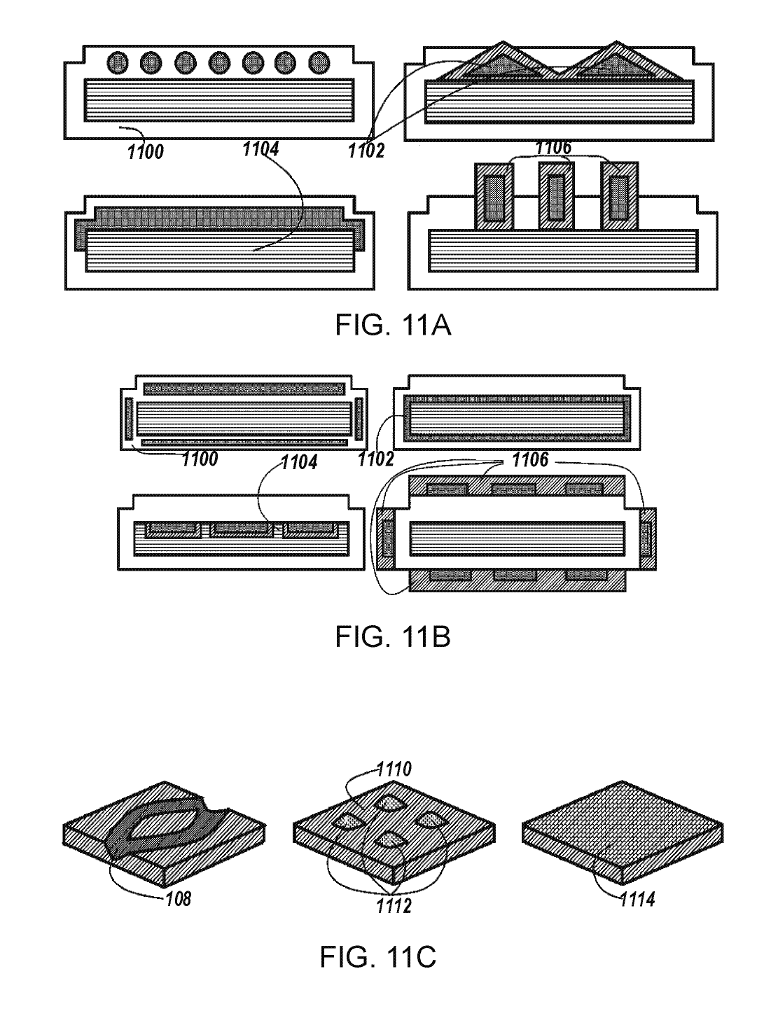

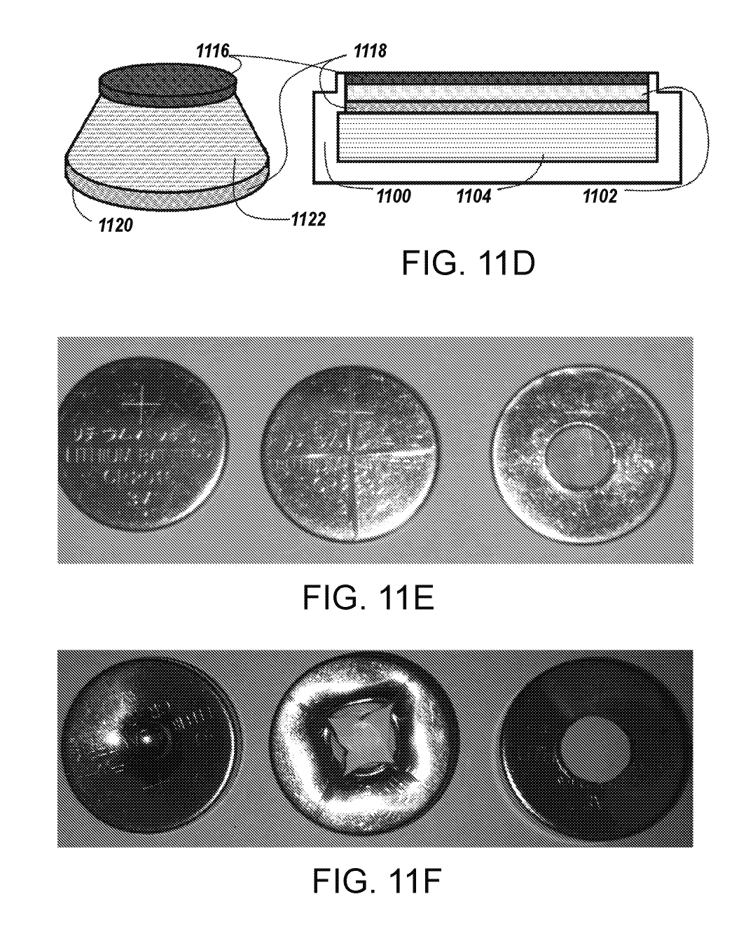

Mechanically triggered, thermally triggered, or both mechanically and thermally triggered cell cases and cell case components may exhibit one or multiple geometries, orientations, surface features, and materials. Schematics depicting several examples of those constructions and features are shown in FIG. 11A, FIG. 11B, FIG. 11C, and FIG. 11D, which include a mechanically responsive case 1100, thermal runaway retarding and/or flame retarding additives 1102, electrode stacks 1104, mechanically responsive case components 1106, groove surface features 1108, mechanically responsive cell component surface 1110, bump surface features 1112, crack pattern surface features 1114, reinforced metal segment 1116, brittle ceramic segment 1118, mechanically responsive additive containing case component 1120, and deformable composite segment 1122.

We tested the impact response of surface feature modified and locally anisotropic/heterogeneous material modified battery cell components, using groove modified and silica glass modified stainless steel bottom shell components, as shown in FIG. 11E. The cell case components were made by modifying the bottom shell of 304 stainless steel CR2032 cell case with seal O-ring (provided by AA Portable Power Corp, part #2032OR1). In one scenario, a rotating table saw was used to create two grooves perpendicular to each other on the surface of the shell intersecting at the center. In another scenario, a 9/32″ diameter hole is removed from the center of the shell using a hand punch and replaced with a piece of 1 mm thick silica glass and sealed by epoxy. Unmodified reference cells were also tested. The processing procedure of the battery cells was similar with that in Example 10.

Impact tests were performed on battery cells made of reference shell components, surface feature modified shell components, and dissimilar material modified shell components. A 7 kg cylindrical steel hammer was dropped from a distance of 15 cm onto a ¼″ diameter brass ball indenter which had been suspended 5 mm above the center of the component structures. The shell components were affixed to a ½″ thick circular polyurethane base using masking tape prior to impact.

An image of the shell components after impact is shown in FIG. 11F. It can be seen that the modifications to the shells allow those components to rupture under the impact loading, exposing the volume on the opposite side; while the unmodified reference shell does not. The image indicates that surface features and dissimilar material structures can be used to promote, guide, or define the mechanical response of cell case components to mechanical abuse. It is also representative of how geometries and orientations can be used to promote, guide, or define the mechanical response of cell case components to mechanical abuse. Additionally, similar modifications to cell case components can be used to promote, guide, or define the thermal response of cell case components to thermal abuse; e.g., locally anisotropic/heterogeneous material structures with controlled melting points or softening temperatures can be employed.

The mechanically triggered, thermally triggered, or both mechanically and thermally triggered cell case and cell case component structure geometries may be small, big, narrow, wide, shallow, or tall, with respect to the characteristic length of the cell. They may be formed with a variety of cross-sectional geometries including but not limited to straight lines, curves, nodes or dots, triangles, circles, ovals, polygons, ellipses, squares, rectangles, trapezoids, polygons, crescents, crescents, stars, concave shapes, convex shapes, irregular shapes, or any combination of them; and may be formed with a variety of three-dimensional geometries including but not limited to cylinders, cones, spheres, boxes, shells, convex-shapes, concave-shapes, multilayered structures, sectioned structures, telescoping structures, springs, coils, trusses, etc., or any combination of them. They may have hollow, depressed, or voided areas and may be filled with additives, additional materials, or additional components. Several examples are depicted in FIG. 11A.

The mechanically triggered, thermally triggered, or both mechanically and thermally triggered cell case and cell case component structures may be oriented in any direction across, through, around, within, parallel to, perpendicular to, diagonal to, next to, away from, above, or below one or multiple defining, discrete, or abstract features of the electrode stack or another cell case component. Several examples are depicted in FIG. 11B.

The mechanically triggered, thermally triggered, or both mechanically and thermally triggered cell case and cell case component structures may include one or multiple surface features including but not limited to bumps, notches, grooves, cracks, folds, ridges, valleys, kinks, folds, etc., or any combination of them. Such features may form patterns which may be straight, curved, short, long, narrow, wide, shallow, or tall (compared to the characteristic length of the component) and may be connected, intersected, or separate. The spacing among the features may be uniform or non-uniform and their distribution may be homogeneous or heterogeneous as well as isotropic or anisotropic. Several examples are depicted in FIG. 11C.

The mechanically triggered, thermally triggered, or both mechanically and thermally triggered cell case and cell case component structures may be constructed from a variety of materials including metals, ceramics, polymers, composites, alloys, elastomers, glasses, carbons, or a combination of them. The materials may be uniform or non-uniform and their distribution may be homogeneous or heterogeneous as well as isotropic or anisotropic. Several examples are depicted in FIG. 11D.

### Example 12

### Mechanically/Thermally Triggered Containers, Components, and Elements Supporting Thermal Runaway Mitigating and Fire Mitigating Materials Internal to the Cell Case

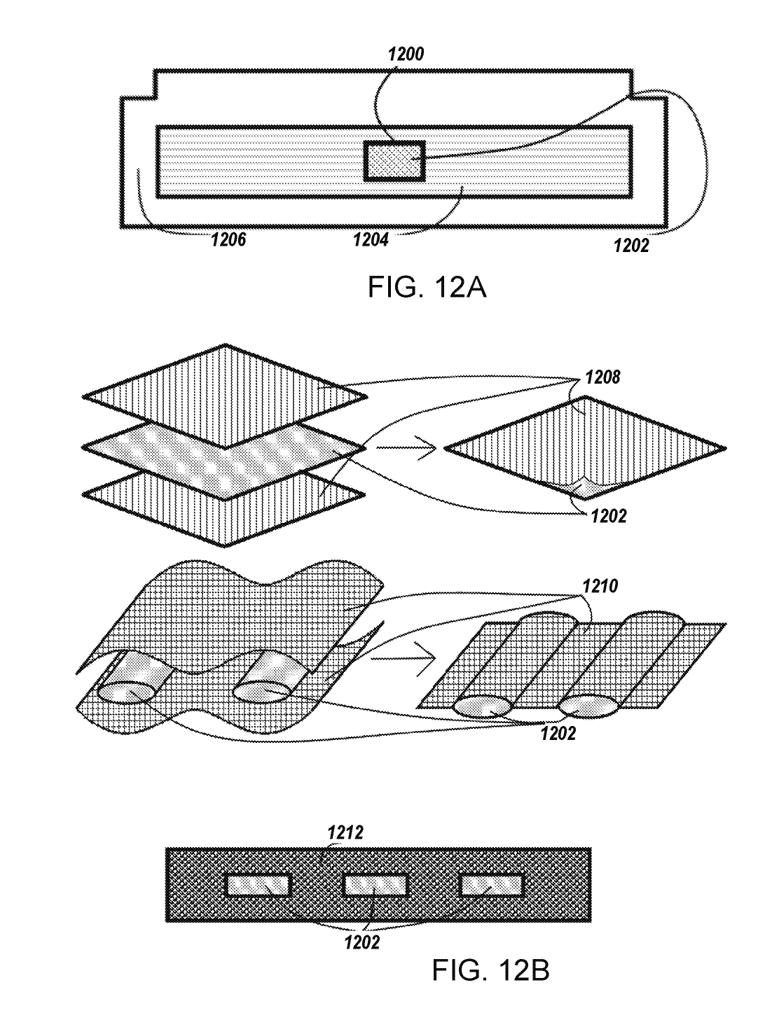

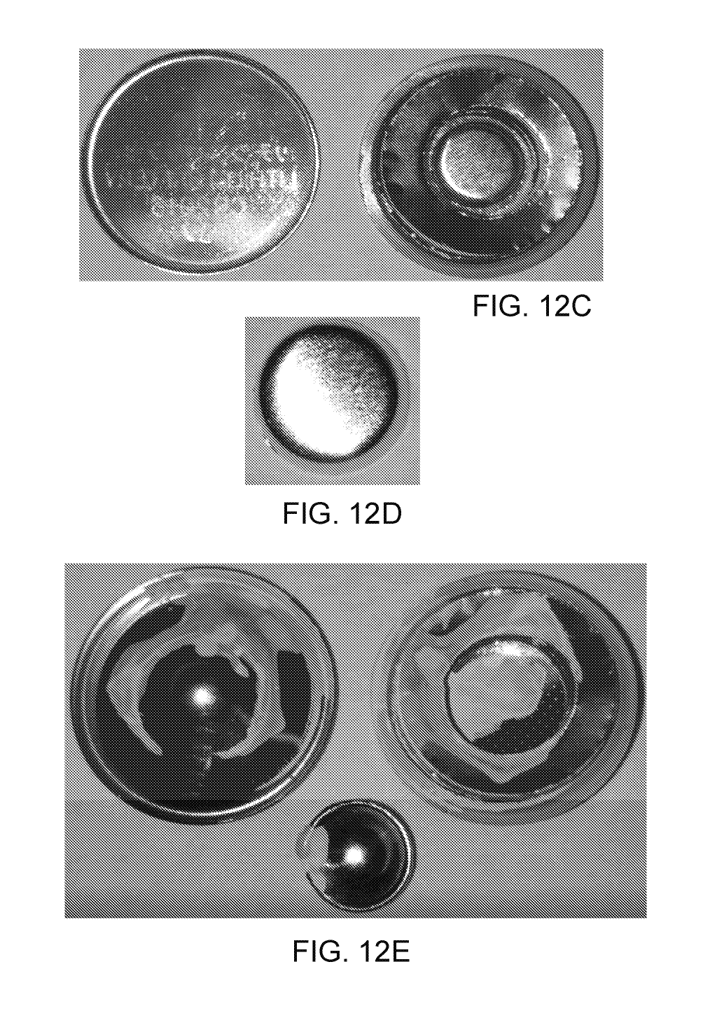

In one embodiment, we employ mechanically triggered, thermally triggered, or both mechanically and thermally triggered containers, components, and elements supporting thermal runaway mitigating materials, fire mitigating materials, or both thermal runaway and fire mitigating materials internal to the cell case. They may be in one or multiple locations above, below, next to, affixed to, adjacent to, incorporated into or within the electrode stack, including cathode, anode, charge collectors, separator, electrolyte, as well as other components in the battery cell. Schematics depicting several examples are shown in FIG. 12A and FIG. 12B, which include mechanically and/or thermally responsive element 1200 (e.g. container or component), thermal runaway retarding and/or flame retarding additive 1202, electrode stack 1204, mechanically responsive case structure 1206, charge collector section 1208, separator section 1210, and composite electrode section 1212. We tested the impact response of one such additive supporting mechanically triggered pouch component inside a modified battery cell, as shown in FIG. 12C.

The mechanically triggered additive supporting aluminum pouch component was made using a standard direct scanning calorimetry 50 μL capacity sample pan and cover (provided by Perkin Elmer part #02190041). The pan was filled with white dye (i.e. correction fluid) and sealed with the cover using a standard sample pan crimping press (provided by Perkin Elmer part #02190048). An image was shown in FIG. 12D. The modified battery cell was made by placing the mechanically triggered additive supporting aluminum pouch component in the center of a 304 stainless steel CR2032 cell case with seal O-ring (provided by AA Portable Power Corp, part #2032OR1). An electrode stack was harvested from a commercially available LIR2450 cell (3.6 V, 120 mAh, 0.43 Wh) (provided by AA Portable Power Corp, part #LIR2450) and the individual electrodes are separated. Pieces of both electrodes were cut into circles with holes in the middle, sized to fill the area in the CR2032 cell case around the pouch using a razor. A trilayer polypropylene-polyethylene membrane (PP/PE/PP) (provided by Celgard) was also cut into circles with holes in the middle of the same size. Five layers of cathode, anode, and separator were placed on both sides of the pouch and 100 μL of electrolyte (1M LiPF6 in 1:1 EC-EMC) (provided by BASF) was added. The battery cell was then sealed with polyimide tape, completing construction of the modified battery cell. Impact test was performed on the modified battery cell, through a similar procedure with that of Example 11.

An image of the modified battery cell after impact is shown in FIG. 12E. It can be seen that white dye covers the interior of the cell, demonstrating the effective delivery of the additive. This represents how mechanically triggered containers, components, and elements supporting thermal runaway mitigating, fire mitigating, or both thermal runaway and fire mitigating materials internal to the cell case can be incorporated into the cell design, electrode stack design, or internal battery environment serving to reduce or retard heat generation or accrued temperature or prevent, reduce, retard, or extinguish a fire due to mechanical abuse, or reduce the flammability of battery components such as electrolyte. It is also representative of how thermally responsive containers, components, and elements supporting thermal runaway mitigating, fire mitigating, or both thermal runaway and fire mitigating materials internal to the cell case can be incorporated into the cell design, electrode stack design, or internal battery environment serving to reduce or retard heat generation or accrued temperature or prevent, retard, reduce, or extinguish a fire due to thermal abuse, or reduce the flammability of battery components such as electrolyte.

The mechanically triggered, thermally triggered, or both mechanically and thermally triggered containers, components, and elements supporting thermal runaway mitigating materials, fire mitigating materials, or both thermal runaway and fire mitigating materials internal to the cell case may be incorporated into the design of electrode stack structures, components, and elements (including cathode, anode, charge collectors, and separators which may also be mechanically or thermally responsive) to deliver thermal runaway mitigating, fire mitigating, or both thermal runaway and fire mitigating materials retained within the battery cell. One or multiple additive supporting containers, components, and elements may be arranged in one or multiple locations above, below, next to, affixed to, adjacent to, incorporated into or within the electrode stack (including cathode, anode, charge collectors, separator, and electrolyte).

Mechanically triggered, thermally triggered, or both mechanically and thermally triggered containers, components, and elements supporting thermal runaway mitigating materials, fire mitigating materials, or both thermal runaway and fire mitigating materials internal to the cell may be made up of one or multiple of geometries, orientations, surface features, and materials.

The mechanically triggered, thermally triggered, or both mechanically and thermally triggered containers, components, and elements supporting thermal runaway mitigating materials, fire mitigating materials, or both thermal runaway and fire mitigating materials internal to the cell case may incorporate or be made up of one or multiple preexisting elements of the electrode stack structure (including cathode, anode, charge collectors, separator, and electrolyte). The containers, components, and elements internal to the cell may also be independent of the preexisting elements of the electrode stack structure and simply be included or located within its environment. Such a container, component, or element internal to the cell may be formed using none of, part of, or the entirety of one or multiple electrode stack elements. A single electrode stack element may also be used to form part of or the entirety of one or multiple mechanically triggered, thermally triggered, or both mechanically and thermally triggered containers, components, and elements internal to the cell. Several examples are depicted in FIG. 12B.

The thermal runaway mitigating or fire mitigating material or additive contained in such a container, component, or element may include any and all functional solids, liquids, gases, solutions, suspensions, emulsions, foams, gels, plasmas, or any combinations of them, which serve to mitigate heat generation or accrued temperature or prevent, retard, reduce, or extinguish a fire in response to mechanically or thermally abusive event, or reduce the flammability of electrolyte or other battery components.

### Example 13

### Mechanically and Thermally Triggered Container, Component, and Element Internal to the Cell Case Geometries, Orientations, Surface Features, and Materials

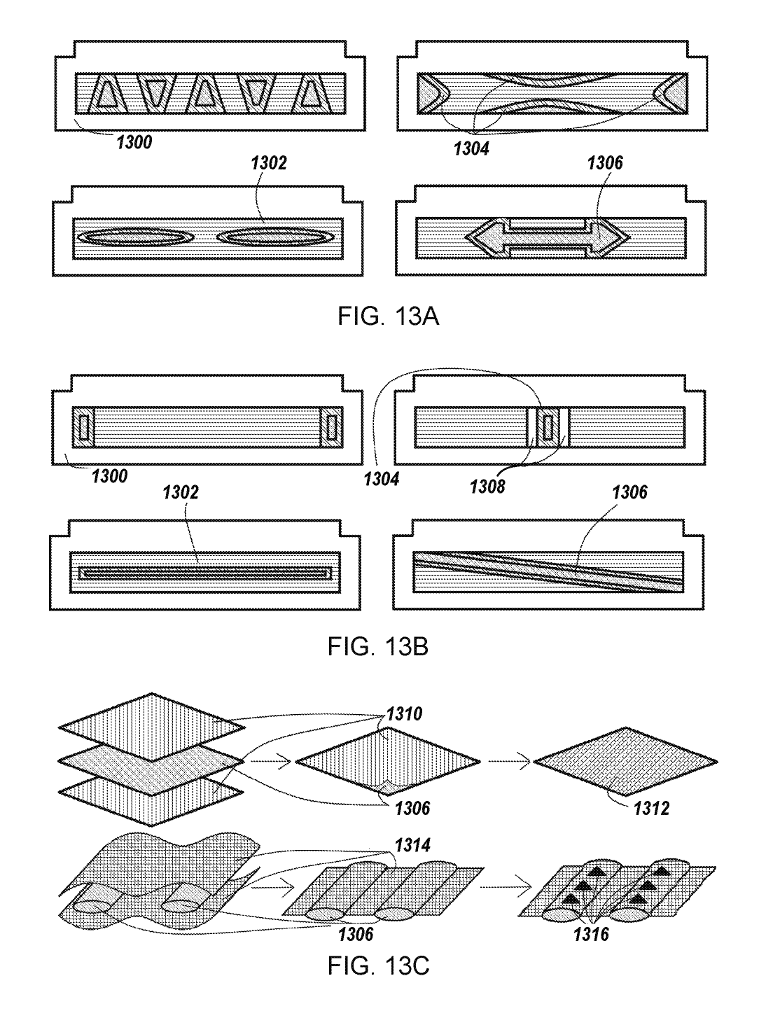

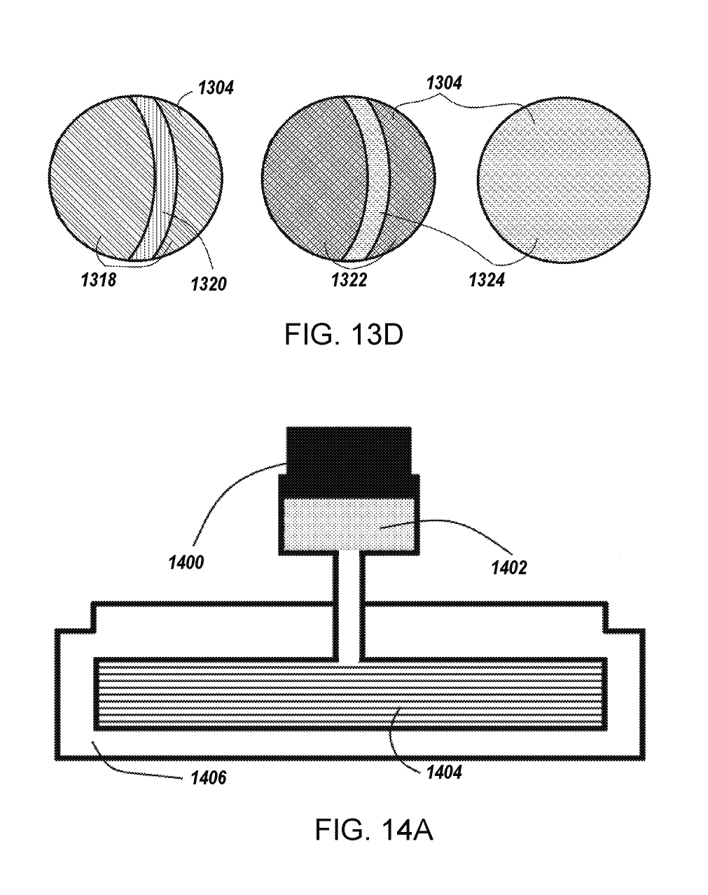

In one embodiment, mechanically triggered, thermally triggered, or both mechanically and thermally triggered containers, components, and elements internal to the cell case may exhibit one or multiple geometries, orientations, surface features, and materials. Schematics depicting several examples are shown in FIG. 13A, FIG. 13B, FIG. 13C, and FIG. 13D, which include cell case 1300, electrode stack 1302, mechanically and/or thermally responsive containers, components, elements 1304 internal to the cell case, thermal runaway retarding and/or flame retarding additive 1306, free volume internal to the cell case 1308, mechanically and/or thermally responsive charge collector section 1310, crack pattern surface feature 1312, mechanically and/or thermally responsive separator section 1314, and jagged or sharp surface features 1316, reinforced metal material 1318, brittle ceramic material 1320, high melting point polymer material 1322, and low melting point polymer material 1324.

The mechanically triggered, thermally triggered, or both mechanically and thermally triggered containers, components, and elements internal to the cell case geometries may be small, big, narrow, wide, shallow, or tall, with respect to the characteristic length of the cell. They may be formed with a variety of cross-sectional geometries including but not limited to straight lines, curves, nodes or dots, triangles, circles, ovals, polygons, ellipses, squares, rectangles, trapezoids, polygons, crescents, crescents, stars, concave shapes, convex shapes, irregular shapes, or any combination of them, and may be formed with a variety of three-dimensional geometries including but not limited to cylinders, cones, spheres, boxes, shells, convex-shapes, concave-shapes, multilayered structures, sectioned structures, telescoping structures, springs, coils, trusses, etc., or any combination of them. They may have hollow, depressed, or voided areas and may be filled with additives, additional materials, or additional components. Several examples are depicted in FIG. 13A.

The mechanically triggered, thermally triggered, or both mechanically and thermally triggered containers, components, and elements internal to the cell case may be oriented in any direction across, through, around, within, parallel to, perpendicular to, diagonal to, adjacent to, next to, away from, above, or below one or multiple defining, discrete, or abstract features of the electrode stack or another cell case component. Several examples are depicted in FIG. 13B.

The mechanically triggered, thermally triggered, or both mechanically and thermally triggered containers, components, and elements internal to the cell case may include one or multiple surface features including but not limited to bumps, notches, grooves, cracks, folds, ridges, valleys, etc., or any combination of them. Such features may form patterns which may be straight, curved, short, long, narrow, wide, shallow, or tall, compared to the characteristic length of the component, and may be connected, intersected, or separate. The spacing among the features may be uniform or non-uniform and their distribution may be homogeneous or heterogeneous as well as isotropic or anisotropic. Several examples are depicted in FIG. 13C.

The mechanically triggered, thermally triggered, or both mechanically and thermally triggered containers, components, and elements internal to the cell case may be constructed from a variety of materials including metals, ceramics, polymers, composites, elastomers, alloys, glasses, carbons, or any combination of them. The materials may be uniform or non-uniform and their distribution may be homogeneous or heterogeneous as well as isotropic or anisotropic. Several examples are depicted in FIG. 13D. It should be noted that in this invention, the containers, components, and elements may be optional, depending on the requirements of the thermal runaway and fire mitigating materials.

### Example 14

### Mechanically and Signal Triggered Devices and Components Delivering Thermal Runaway Mitigating and Fire Mitigating Materials Into the Battery Cell From the Cell Case or From Outside the Cell Case

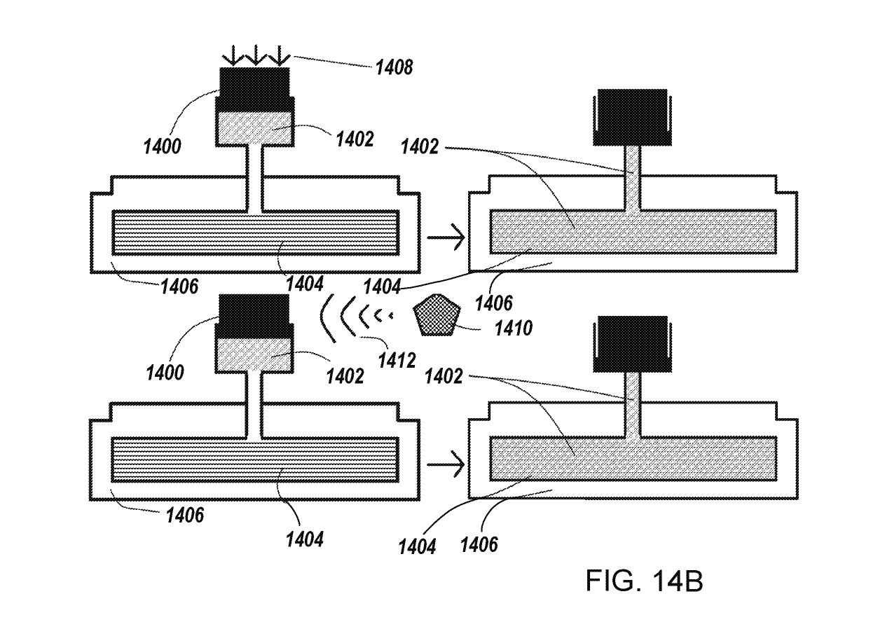

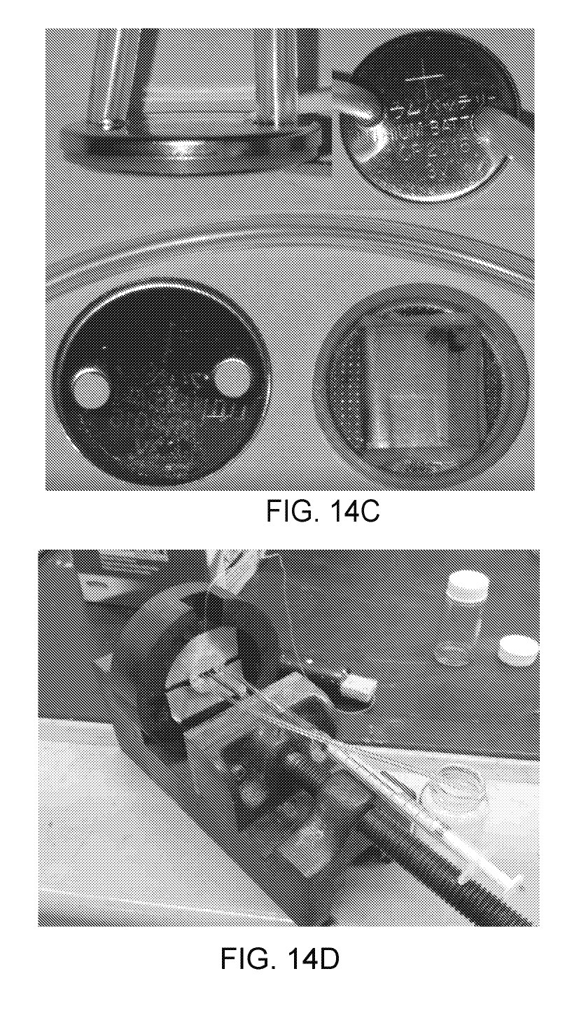

In one embodiment, we employ mechanically triggered, signal triggered, or both mechanically and signal triggered devices and components to deliver thermal runaway mitigating materials, fire mitigating materials, or both thermal runaway and fire mitigating materials or additives into the battery cell from the cell case or from outside the cell case. The setup shown in FIG. 14A depicts a cross-section of one such device design having a mechanically responsive or signal triggered device 1400, a thermal runaway retarding and/or flame retarding additive 1402, an electrode stack 1404, and a cell case 1406. Schematics depicting several additional examples are shown in FIG. 14B, which includes a mechanical event 1408, a sensor 1410 of a computer, and a sensor or computer signal 1412. We tested one such signal triggered device for delivering thermal runaway mitigating material into the battery cell from the cell case or from outside the cell case using a multilayered lithium-ion battery cell with a modified LIR2450 type cell case, where a simulated signal triggered syringe component containing 1,5-pentanediol additive was connected by polyvinylchloride tubing to the stainless steel bottom shell component of the cell case structure, as shown in FIG. 14C (using LIR2032 sized model). The signal triggered device was made by connecting an additive containing syringe component to a cell case by polyvinylchloride tubing. The cell case was constructed by modifying a 304 stainless steel CR2450 cell case with seal O-ring (provided by AA Portable Power Corp, part #2450OR304-1). The modified cell case was made by removing two 3/32″ diameter holes from the opposite edges of the bottom shell component, 3/32″ away from the inner diameter of the perimeter using a hand punch. The battery cell was assembled using a LiCoO₂/C multilayered electrode stack (including cathode, anode, charge collectors, separator, and electrolyte) harvested from a commercially available LIR2450 cell (3.6 V, 120 mAh, 0.43 Wh) (provided by AA Portable Power Corp, part #LIR2450) sealed in the modified cell case. The commercially available cells was first charged by constant current—constant voltage algorithm (C/12→C/150) to 4.2 V using a battery analyzer (provided by MTI, item #BST8-3). The fully charged cell was then disassembled and the multilayered electrode stack was removed using a crimping and disassembling press with a CR2450 disassembling die set (provided by MTI, item #MSK110D-DS2450). The harvested electrode stack was placed in the modified cell case and sealed using a crimping and disassembling press with a CR2450 crimping die set (provided by MTI, item #MSK110-DS2450). A 1 mL syringe was filled with 400 μL of 1,5-pentanediol (provided by Sigma Aldrich, SKU #76892) and connected to the cell using polyvinylchloride tubes ( 3/32″ outer diameter, 1/32″ inner diameter) (provided by McMaster-Carr, product #5155T11). One end of each of two polyvinylchloride tubes were inserted into the holes on the bottom shell of the cell case and the interfaces between the tubes and the holes were sealed with silicone grease. The needle of the additive containing syringe component was inserted into to the opposite end of one of the polyvinylchloride tubes and opposite end of the other tube was routed to a waste collection bottle, completing the assembly. Reference devices were prepared through a similar procedure, except that no thermal runaway mitigating material (e.g. 1,5-pentanediol additive) was included in the signal triggered syringe component.

Nail tests were performed on both reference devices and additive delivering devices. The cell component of the device was affixed to a ½″ thick circular polyurethane base using masking tape and set against one jaw of a standard drill-press vise (provided by McMaster-Carr, product #52855A21). The ⅛″ diameter steel nail was loaded into the vise with the tip pressed against the center of the cell component and the head pressed against the opposite jaw of vise. Simultaneously, the nail was drilled into the cell using the vise and the additive was triggered to be injected into the cell, as shown in FIG. 14D. Temperature response of the nail-penetrated battery cell was measured with a type-K gage 40 thermocouple (provided by Omega, part #TT-K-40-25) equipped with a temperature logging data acquisition system (provided by Omega, part #OM-EL-USB-TC), with a recording interval of 1 second. The thermocouple tip was affixed to the stainless steel bottom shell component of the cell with polyimide tape, 5 mm away from the outer diameter of where the nail was drilled.

The temperature response testing results are shown in FIG. 14E. The temperature profiles show that by employing a signal triggered device for delivering thermal runaway mitigating additive into the battery cell, heat generation and accrued temperature can be significantly reduced. It is also representative of how fire mitigating additive delivered into the cell through a signal triggered device could be employed to prevent, retard, reduce, or extinguish a fire due to mechanical abuse, or to reduce the flammability of electrolyte or other battery components. Such signal triggered devices could also be employed to deliver thermal runaway mitigating or fire mitigating materials which serve to reduce or retard heat generation or accrued temperature or prevent, retard, reduce or extinguish a fire due to thermal abuse, or reduce the flammability of electrolyte or other battery components. Additionally, similarly designed mechanically triggered devices for delivering thermal runaway mitigating or fire mitigating additives may serve to reduce or retard heat generation or accrued temperature or prevent, retard, reduce, or extinguish a fire due to mechanical abuse, or reduce the flammability of electrolyte or other battery components.

The triggering signals could be from sensors, detectors, or relays, etc., which respond to temperature, motion, deformation, stress, strain, displacement, acceleration, deflection, distance, wave, force, pressure, loadings, voltage, current, sound, or magnetic fields, etc.; or from the loadings or heat associated with the mechanical or thermal abuse without any sensor or detector; or from any combination of them. The additive motion could be promoted by pumps, pre-stressed containers, syringes, springs, pistons, deformable membranes or containers, levers, gears or gear systems, weights, energy absorption materials and devices, blocks, plates, sliding materials and devices, thermally activated materials or devices, mechanically activated materials or devices, etc., or any combination of them.

The additives and additive delivering materials or devices may be incorporated into or external to the cell case. The additives and additive delivering materials or devices may comprise any mechanically responsive entity which serves to deliver thermal runaway mitigating or fire mitigating material into the battery cell (including electrode stack, cell case or cell case components). Such a mechanically responsive entity may include but not be limited to a spring, syringe, piston, plunger, auger, pump, valve, actuator, vacuum, compressor, etc. The mechanically responsive entity may be triggered to deliver the material into the cell upon response to a physical event or may be triggered by a signaling element. The signaling element may be sensor, a controller, a microprocessor, a computer, or any combination or none of them. Examples of such sensors and computers may include but not be limited to temperature sensors, pressure sensors, motion sensors, fluid level sensors, light sensors, electrical current sensors, voltage sensors, battery management computers, thermal management computers, process control computers, etc. The sensors and computers may be coupled to the material delivering device, battery cells, or an outside system. Several examples are given in FIG. 14B.

The thermal runaway mitigating or fire mitigating material or additive delivered into the cell by the mechanically or signal triggered device may include any and all functional solids, liquids, gases, solutions, suspensions, emulsions, foams, gels, plasmas, or combinations of, which serve to mitigate heat generation or accrued temperature or prevent, retard, reduce or extinguish a fire in response to mechanically or thermally abusive event, or reduce the flammability of electrolyte or other battery components.

### Example 15

### Mechanically Triggered Pipes, Ducts, Tubes, and Channels Hosting Thermal Runaway Mitigating and Fire Mitigating Materials

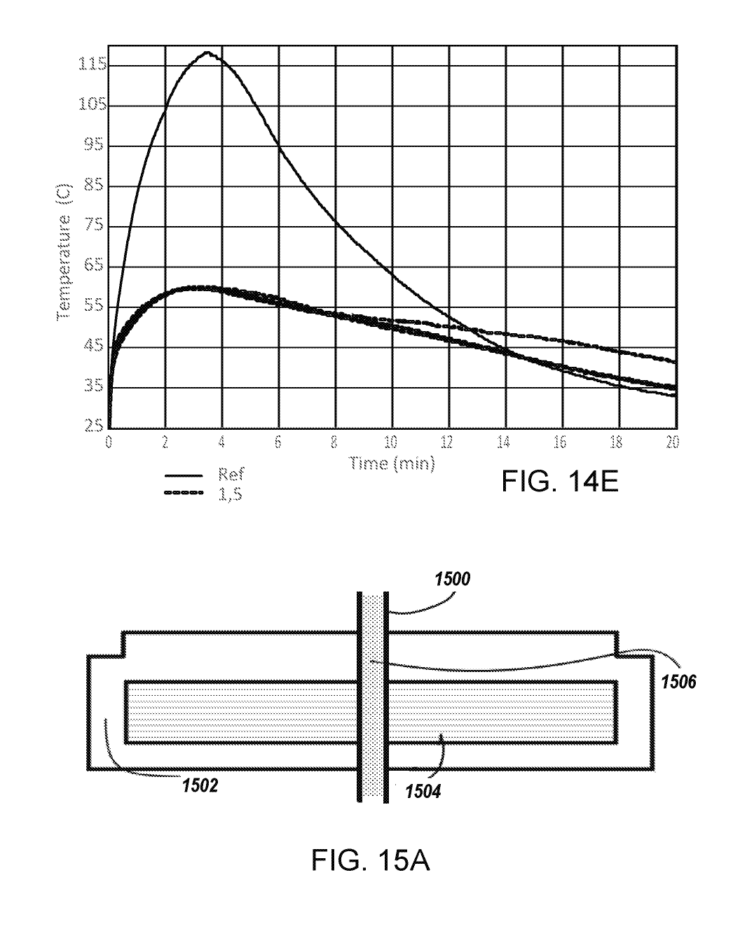

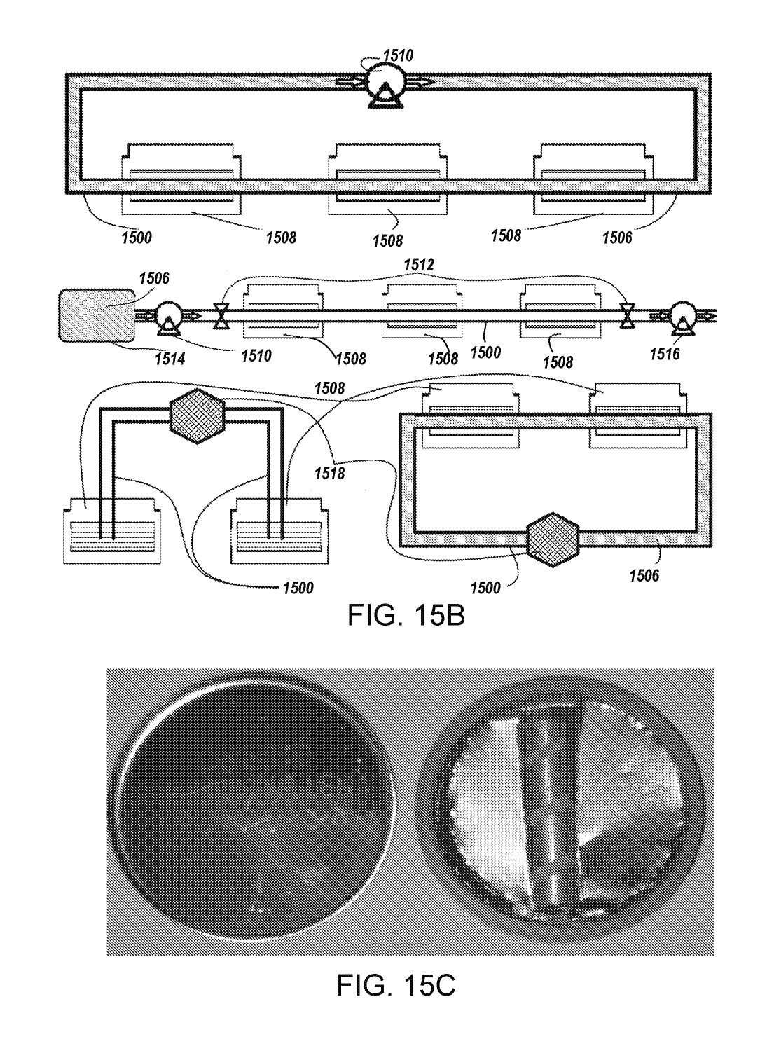

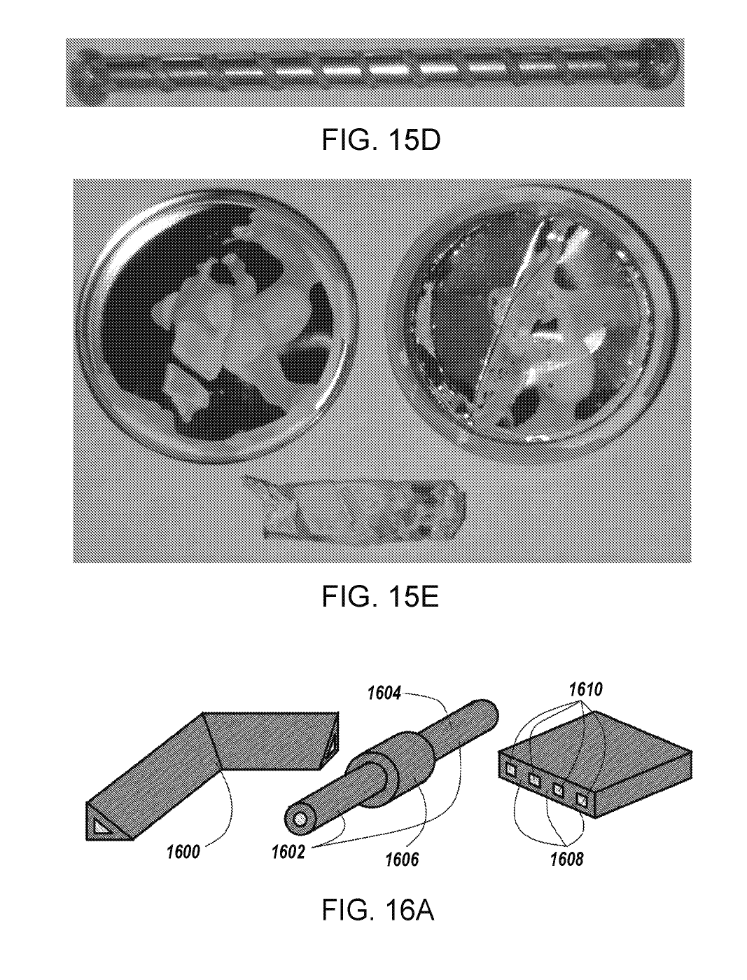

In one embodiment, we employ mechanically triggered pipes, ducts, tubes, containers, reservoirs, and channels hosting thermal runaway mitigating materials, fire mitigating materials, or both thermal runaway and fire mitigating materials. They may be inside, outside, incorporated into, or connected to one or multiple cell case or cell case component structures and involve one or more battery cells. They may also incorporate one or multiple outside piping, duct, tube, or channel systems with or without an additional additive source, reservoir, container, bottle, or vessel. The outside systems may be coupled to signaling elements, controllers, or both signaling elements and controllers. Schematics depicting several examples are shown in FIG. 15A and FIG. 15B, which include a mechanically responsive pipe, duct, tube, or channel 1500, a mechanically responsive case structure 1502, an electrode stack 1504, a thermal runaway retarding and/or flame retarding additive 1506, battery cells 1508, a pump 1510, valves or actuators 1512, an additive reservoir or vessel 1514, vacuum pump 1516, and outside piping, duct, tube, or channel system 1518.

We tested the impact response of a surface feature modified, additive containing, mechanically triggered pipe inside a modified battery cell, as shown in FIG. 15C.The surface feature modified, additive containing pipe was made by modifying a 3003 aluminum tube ( 3/32″ outer diameter, 1/16″ inner diameter) (provided by McMaster-Carr, product #7237K13). The tube was cut to 1.5 cm in length using a rotating table saw, and then tightly wrapped with 6 mm wide polyimide tape at a 66° pitch angle (with respect to the tube length). The tube was placed in a saline sulfate aluminum etchant solution (14 g CuSO₄, 28 g NaCl, 5 mL H₂SO₄, 200 mL H₂O) for 10 minutes. Upon removal the tube was rinsed with water, the polyimide tape was removed, and it was scrubbed with a brush, exposing a spiral groove surface pattern with a depth of about 0.01″. The tube was filled with white dye (i.e. correction fluid) and sealed on both ends with epoxy, completing construction of the surface feature modified, additive containing pipe. An image is shown in FIG. 15D.

The modified battery cell was made by placing the surface feature modified, additive containing pipe in the center of a 304 stainless steel CR2032 cell case with seal O-ring (provided by AA Portable Power Corp, part #2032OR1). An electrode stack was harvested from a commercially available LIR2450 cell (3.6 V, 120 mAh, 0.43 Wh) (provided by AA Portable Power Corp, part #LIR2450) and the individual electrodes were separated. Pieces of both electrodes were cut into crescent shapes sized to fill the area in the CR2032 cell case on either side of the pipe using a razor. A trilayer polypropylene-polyethylene membrane (PP/PE/PP) (provided by Celgard) was also cut into crescent shapes of the same size. Five layers of cathode, anode, and separator were placed on both sides of the pipe and 100 μL of electrolyte (1M LiPF6 in 1:1 EC-EMC) (provided by BASF) was added. The battery cell was then sealed with polyimide tape, completing construction of the modified battery cell. Impact test was performed on the modified battery cell; the procedure was similar with that of Example 11.

An image of the modified battery cell after impact is shown in FIG. 15E. It can be seen that white dye covers the interior of the cell, demonstrating effective delivery of the additive. This represents how mechanically triggered pipes, ducts, tubes, and channels hosting thermal runaway mitigating, fire mitigating, or both thermal runaway and fire mitigating materials can be incorporated into the cell design to reduce or retard heat generation or accrued temperature or prevent, retard, reduce, or extinguish a fire due mechanical abuse, or reduce the flammability of electrolyte or other battery components.

Mechanically triggered pipes, ducts, tubes, and channels may be incorporated into the design of cell structures (which may also be mechanically triggered, thermally triggered, or mechanically and thermally triggered), cell component structures (which may also be mechanically triggered, thermally triggered, or mechanically and thermally triggered), and electrode stack structures (including cathode, anode, charge collectors, and separators) to deliver thermal runaway mitigating, fire mitigating, or both thermal runaway and fire mitigating materials from outside the battery cell. They can be a part of, incorporated in, next to, or embedded in battery cooling systems, battery cell cases, battery module or pack walls, battery support systems, or any combination of them. One or multiple additive hosting pipes, ducts, tubes, or channels may be arranged in one or multiple locations attached to, affixed to, or incorporated into anywhere above, below, adjacent, outside, or within the case structure, cell component structures, electrode stack structures, or combination thereof. Mechanically triggered pipes, ducts, tubes, and channels may be made up of one or multiple geometries, orientations, surface features, and materials. The mechanically triggered pipes, ducts, tubes, and channels may incorporate more than one cell and may incorporate one or more additive containing sources, reservoirs, or vessels. They may be pressurized or depressurized and may be connected to one or more pumps, valves, actuators, vacuums, or combinations thereof. Such elements may be a part of or make up a piping, duct, tube, or channel system. Such a system may be inside, outside, or incorporated into the cell design. Such systems may include but are not limited to thermal management systems (e.g. antifreeze lines), hydraulic systems (e.g. steering fluid lines, brake fluid lines), lubrication systems (e.g. motor oil lines, transmission lines), cleaning systems (e.g. window washer fluid lines), fire safety systems (e.g. sprinkler lines), exhaust systems, fuel systems, propellant systems, cryogenic systems, plumbing systems, process systems, pressure vessel systems, etc. These systems may be coupled to sensors or computers which may include but not be limited to temperature sensors, pressure sensors, motion sensors, fluid level sensors, light sensors, electrical current sensors, voltage sensors, battery management computers, thermal management computers, process control computers, etc. The sensors and computers may be further coupled to the pipes, ducts, tubes, channels, battery cells, or another outside system. Such a system may or may not be or have been specifically designed or intended to be mechanically responsive or deliver thermal runaway mitigating, fire mitigating, or both thermal runaway and fire mitigating materials into battery cells as its original or primary function. Several examples are depicted in FIG. 15B.

Segments of mechanically triggered pipes, ducts, tubes, or channels may be thermally responsive if that segment is incorporated into a thermally triggered or mechanically and thermally triggered cell case, cell case component, or internal element of the battery design if it helps to facilitate delivery of thermal runaway mitigating materials, fire mitigating materials, or both thermal runaway and fire mitigating materials by the mechanically triggered pipes, ducts, tubes, or channels into the battery cell.

The thermal runaway mitigating or fire mitigating material or additive hosted by such pipes, ducts, tubes, and channels may include any and all functional solids, liquids, gases, solutions, suspensions, emulsions, foams, gels, plasmas, or combinations of, which serve to mitigate heat generation or accrued temperature or prevent, retard, or extinguish a fire in response to mechanically or thermally abusive event.

### Example 16

### Mechanically Triggered Pipe, Duct, Tube, and Channel Geometries, Orientations, Surface Features, and Materials

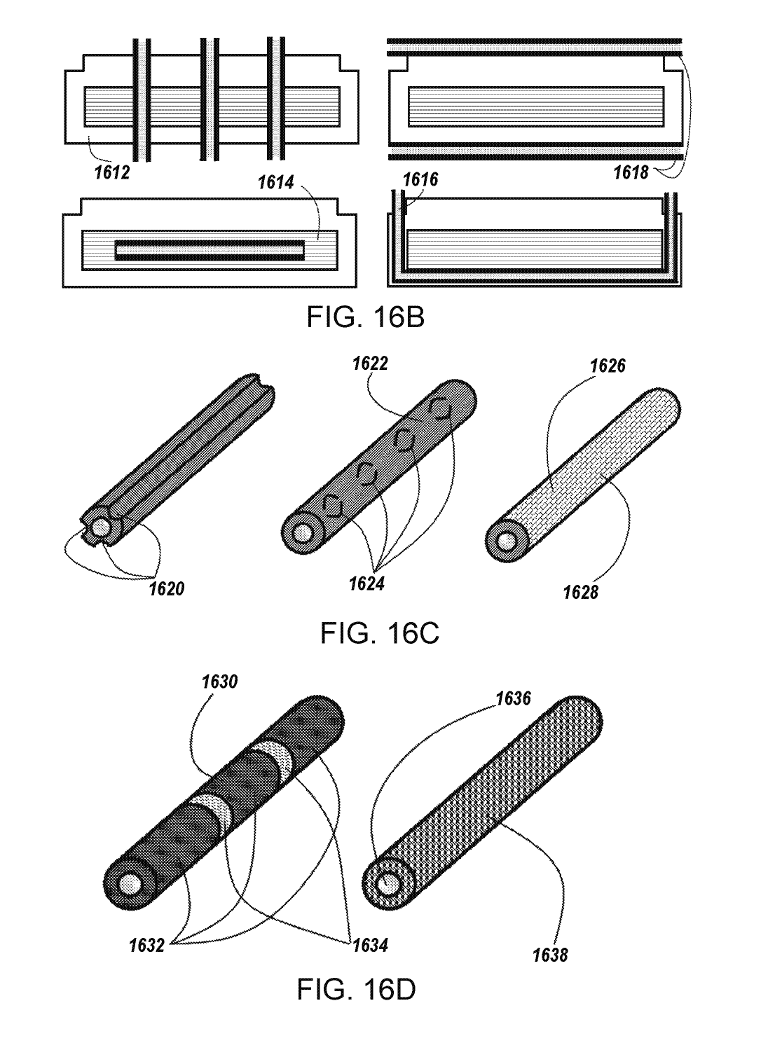

Mechanically triggered pipes, ducts, tubes, and channels may exhibit one or multiple geometries, orientations, surface features, and materials. Schematics depicting several examples are shown in FIG. 16A, FIG. 16B, FIG. 16C, and FIG. 16D, which include a bent section 1600, constricted sections 1602, mechanically responsive pipe, duct, tube, or channel sections 1604, bulged sections 1606, interconnected sections 1608, thermal runaway retarding and/or flame retarding additives 1610, mechanically responsive case 1612, electrode stack 1614, thermal runaway retarding and/or flame retarding additives 1616, mechanically responsive pipes, ducts, tubes, and/or channels 1618, groove surface features 1620, mechanically responsive pipe, duct, tube, or channel sections 1622, notch surface features 1624, mechanically responsive pipe, duct, tube, or channel sections 1626, crack pattern surface features 1628, mechanically responsive pipe, duct, tube, or channel sections 1630, reinforced metal material sections 1632, brittle ceramic material section 1634, thermal runaway retarding and/or flame retarding additives 1636, and deformable woven fiber material section 1638. We tested the impact response of a groove surface feature modified, additive containing pipe inside a modified battery cell, as described in Example 15 and shown in FIG. 15C, FIG. 15D, and FIG. 15E.

The images in FIG. 15C and FIG. 15E indicate that surface features can be used to promote, guide, or define the mechanical response of pipes, ducts, tubes, and channels to mechanical abuse. It is also representative of how geometries, orientations, and material structures can be used to promote, guide, or define the mechanical triggered of pipes, ducts, tubes, and channels to mechanical abuse.

The mechanically triggered pipe, duct, tube, or channel geometries may be small, big, narrow, wide, shallow, or tall (with respect to one or more characteristic cross sections). They may be formed with a variety cross-sectional geometries including but not limited to straight lines, curves, nodes or dots, triangles, circles, ovals, polygons, ellipses, squares, rectangles, trapezoids, polygons, crescents, crescents, stars, concave shapes, convex shapes, irregular shapes, or any combination of them. They may have more than one or changing geometry across their length which may be periodic, multifaceted, bulged, constricted, sectioned, telescoping, etc. They may be straight, bent, curved, coiled, self-connected, interconnected, unconnected, etc. They may be filled with additives but may also contain hollow or voided sections or be devoid of additives. Several examples are depicted in FIG. 16A.

The mechanically responsive pipes, ducts, tubes, or channels may be oriented in any direction across, through, around, within, parallel to, perpendicular to, diagonal to, next to, away from, above, or below one or multiple defining, discrete, or abstract features of the electrode stack, a cell case component, or another pipe, duct, tube, or channel. Several examples are depicted in FIG. 16B.

The mechanically responsive pipes, ducts, tubes, or channels may include one or multiple surface features including but not limited to bumps, notches, grooves, cracks, folds, ridges, valleys, etc. Such features may form patterns which can be straight, curved, short, long, narrow, wide, shallow, or tall (compared to one or more characteristic cross sections or lengths) and may be connected, intersected, or separate. The spacing among the features may be uniform or non-uniform and their distribution may be homogeneous or heterogeneous as well as isotropic or anisotropic. Several examples are depicted in FIG. 16C.

The mechanically responsive pipes, ducts, tubes, or channels may be constructed from a variety of materials including metals, ceramics, polymers, composites, or a combination them. The materials may be uniform or non-uniform and their distribution may be homogeneous or heterogeneous as well as isotropic or anisotropic. Several examples are depicted in FIG. 16D.

The examples of functional solids, liquids, gases, solutions, suspensions, emulsions, foams, gels, plasmas, or combinations of, which serve to mitigate heat generation or accrued temperature, or to prevent, reduce, retard, or extinguish a fire in response to mechanically or thermally abusive event may include but not be limited to: ionic salt compounds (i.e. simple, complex, anhydrous, monohydrate, polyhydrate, acidic, basic, dielectric, magnetic, electrically conducting, electrically insulating, thermally conducting, thermally insulating, hydrophilic, hydrophobic, monovalent, multivalent, neutral, electroplating, electrophoretic, etc.) including but not limited to any and all metal, ammonium, and hydrogen fluorides (e.g. LiF), chlorides (e.g. MgCl₂), bromides (e.g. CuBr₂), iodides (e.g. VnI₃), hydrides (e.g. AlH₃), oxides (e.g. FeO), sulfides (e.g. BaS), nitrides (e.g. ZrN), arsenates (e.g. Co₃(AsO₄)₂), arsenites, phosphates (e.g. K₃PO₄), phosphites, sulfates (e.g. MnSO₄), sulfites, thiosulfates, carbonates (e.g. Na₂CO₃), nitrates (e.g. Zn(NO₃)₂), nitrites, perchlorates (e.g. KClO₄), chlorates, chlorites, hypochlorites, perbromates, bromates (e.g. Ni(BrO₃)₂), bromites, hypobromites, periodates, iodates (e.g. Ca(IO₃)₂), iodites, hypoiodites, manganates (e.g. BaMnO₄), permanganates, chromates (e.g. PbCrO₄), dichromates, acetates (e.g. Ce(CH₃CO₂)₃), formates (e.g. NH₄CO₂H), cyanides (e.g. AgCN), cyanates, thiocyanates, amides (e.g. NaNH₂), oxalates (e.g. CaC₂O₄), peroxides (e.g. SrO₂), hydroxides (e.g. Au(OH)₃), alkoxides, etc.; vinylene carbonate, vinyl ethylene carbonate, allyl ethyl carbonate, vinyl acetate, divinyl adipate, acrylic acid nitrile, 2-vinyl pyridine, maleic anhydride, succinimide, methyl cinnamate, phosphonates, vinyl containing silane-based compounds, halogenated ethylene carbonates, halogenated lactones, etc.; dimethyl carbonate, ethyl methyl carbonate, diethyl carbonate, ethylene carbonate, propylene carbonate, any and all other dialkyl, cyclic, and substituted carbonates, etc.; 6-thiolnicotinamide, ethylenediaminetriacetic acid acetamide, N,N,N′-trimethylethylenediamine, ethylenediaminetetraacetic acid, etc.; sodium lauryl sulfate, sodium dodecylbenzenesulfonate, oleic acid, Span™ series, Atlas™ G series, Tween™ series, Solulan™ series, Splulan™ series, Brij™ series, Arlacel™ series, Emcol™ series, Aldo™ series, Atmul™ series surfactants, non-ionic surfactants, anionic surfactants, cationic surfactants, amphoteric surfactants, etc.; sodium bicarbonate, potassium bicarbonate, aluminum hydroxide, magnesium hydroxide, huntite, hydromagnesite, red phosphorous, borates, organofluorines, organochlorines, organobromines, organoiodides, fluorinated paraffins, chlorinated paraffins, brominated paraffins, iodated paraffins, polymeric fluorinated compounds, polymeric chlorinated compounds, polymeric brominated compounds, polymeric iodated compounds, Freon™ series compounds, Novec™ series compounds, antimony trioxide, organophosphorus componds, triphenyl phosphate, diphenyl phosphate, tricresyl phosphate, trimethyl phosphate, trimethyl phosphite, tris(2,3-dibromopropyl) phosphates, any and all other organic and/or halogenated phosphorus containing compounds (i.e. phosphates, phosphites, phosphinates, etc.), non-flammable gases, nitrogen, carbon dioxide, noble gases, helium, argon, krypton, xenon, chloroform, carbon tetrachloride, water, Aqueous Film Forming Foams, Alcohol-Resistant Aqueous Film Forming Foams, Film Forming Fluoroproteins, Compressed Air Form Systems, class A, class B, class C, class, D, class E, and class F fire extinguisher components, etc.; trimethylamine, triethylamine, N,N-diethylmethylamine, N,N-dimethylethylamine, N,N-diethylaniline, N,N-diethyl-p- phenylenediamine, 2-(2-methylaminoethyl)pyridine, 5-amino-1,3,3-trimethylcyclohexanemethylamine, (1R,2R,)-(+)-1,2-diphenylethylenediamine, N,N′- diphenylethylenediamine, tryptamine, 2-benzylimidazoline, 1,2,3,4-tetrahydro-9H-pyrido[3,4-b]indole, 4,4′diaminodiphenylmethane, 1-(N-box-aminomethyl)-3-(aminemethyl)benzene, pyridine, any and all other tertiary amines; lightly cross-linked polymers such as epoxy, polyester, poly(vinyl ester), polyurethane, bakelite, polyimide, urea methanal, melamine, such co-polymers, etc.; mineral oils, silicones, 1,1-methanediol, 1,2-ethanediol, 1,3-propanediol, 1,4-butanediol, 1,5-pentanediol, 1,6-hexanediol, 1,7-heptanediol, 1,8-octanediol, 1,2-propanediol, 1,2-butanediol, 1,2-pentanediol, 1,2-hexanediol, 1,2-heptanediol, 1,2-octanediol, any and all other glycols, diols, triols, and other polyols, dissolved sugar and salt solutions (e.g. molasses or cane syrup), 2,4,7,9-tetramethyl-5-decyne-4,7-diol, polyethylene glycol hexadecyl ether, polyoxyethylene nonylphynyl ether, sorbitan laurate, polyethylene glycol sorbitan monolaurate, etc.; poly(sodium acrylate), poly acrylic acid-sodium styrene sulfonate, poly(acrylic acid), 2-acrylamido-2methylpropane sulfonic acid, 2-acrylamido-2-methylpropane sulfonic acid poly(ethylene glycol) copolymer, poly(potassium,3sulfopropyl acrylate-acrylic acid) gels, poly(AMPS-TEA-co-AAm), poly(ethylene glycol methyl ether methacrylate-acrylic acid) copolymers, methacrylamidopropyltrimethyl ammonium chloride, bovine serum albumin, casein, lactoferrin, polycations containing aromatics or having a charged backbone such as poly(-vinylpyridine), x,y-ionene, poly(N,N-diallyl-N,N-dimethyl-ammonium chloride); polycations with quaternary ammonium side chains such as poly(trimethylammonio ethylmethacrylate) and its copolymers; polycations without steric stabilizer such as modified polyaspartamide, poly(amidoamine)s with different side groups, poly(N-isopropylacryl amide) and derivatives, poly(dimethylaminoethyl-L-glutamine) and copolymers, poly(methyl methacrylate) and methacrylamide derivatives, poly[2 (dimethylamino)ethyl methacrylamide] and derivatives, polycations with steric stabilizer such as poly(L-lysine) and derivatives, amino acid-based polymers; amphiphilic polycations such as poly(N-ethyl-4-vinylpyridinium bromide) and copolymers, poly(4-vinylpyridine) copolymers; polyamphoters such as modified poly(1,2-propylene H-phosphonate), silica gels, aerogels, etc.; hydroxyl peroxide with potassium iodine or manganese dioxide as catalysts, etc.; polyurethane foaming agents; extinguishing agents in fire extinguishing processes such as ammonium sulfate with sodium bicarbonate solution; solvents having boiling points ranging from 60-250° C. such as acetone, methanol, ethanol, acetonitrile, benzene, carbon tetrachloride, cyclohexane, ethyl acetate, isopropyl alcohol, tert-butyl alcohol and triethylamine etc.; ionic solids such as sodium bicarbonate and potassium bicarbonate; permanganate salts such as silver permanganate, ammonium permanganate, nickel permanganate and copper permangantes; ammonium salts such as ammonium nitrate, ammonium chromates, ammonium citrate, ammonium carbonate and ammonium bicarbonate; coordination compounds such as diaquaamminecobalt chloride, diaquaamminecobalt bromide, cobalt ammines chloride, cobalt ammines nitrate, chromium ammines thiocyanate and nickel ammines chloride; perchlorates such as nitroniumlnitrosonium perchlorates; oxalates such as silver oxalate; azides such as sodium azide, potassium azide, lithium azide and ammonium azide; organic compounds such as azodicarbonamide, azobisisobutyronitrile, n,n′-dinitrosopentamethylenetetramine, 4,4′-oxydibenzenesulfonyl hydrazide, p-toluenesulfonyl hydrazide; hydrated salts such as ammonium copper sulfate hexahydate, nickel sulfate hexahydrate, calcium sulfate hemihydrate, lithium sulfate monohydrate, sodium carbonate monohydrate, borax, nickel oxalate dehydrate, sodium carbonate perhydrate, alkali (Na, K, Rb, NH4) oxalate perhydrate, calcium sulfite, etc.; hydrogen halides, acetic acid, boric acid, carbonic acid, citric acid, nitric acid, oxalic acid, phosphoric acid, sulfuric acid, iron chloride, ferric chloride, stannic chloride, boron trifluoride, malonic acid, barbituric acid, malic acid, maleic acid, etc.; hydroxides (e.g. NaOH), methoxides (e.g. NaOCH₃), ethoxides (e.g. NaOC₂H₅), any and all other alkoxides, carbonates (e.g. Na₂CO₃), ammonia, sodium amide, sodium bis(trimethylsilyl amide), pyridine, methyl amine, imidazole, benzimidazole, histidine, phophazene bases, triethylamine, N,N-diisopropylethylamine, 1,8-diazabicycloundec-7-ene, 2-tert-butyl-1,1,3,3-tetramethylguanidine, potassium tert-butoxide, lithium diisopropyl amide, etc.; polymerizable monomers, polymerizable oligomers, short chained polymers, long chained polymers, alternating copolymers, periodic copolymers, statistical copolymers, block copolymers, graft copolymers, etc.; protic polar liquids, solvents, solutions, suspensions, emulsions, gels, plasmas, and salts (i.e. any and all compounds containing one or more functional groups with labile hydrogen protons (—OH, —SH, —NHR, —NH2) such as alcohols, carboxylic acids, thiols, thio acids, amines, acid amides, diacid amides, etc.) including but not limited to water; methanol, ethanol, 1-propanol, 2-propanol, 1-butanol, 2-butanol, 2-methylpropan-2-ol, any and all other primary, secondary, and tertiary alcohols with and without additional substituents; methanoic acid, ethanoic acid, propanoic acid, butanoic acid, 2-methylpropanoic acid, any and all other linear and branched carboxylic acids with and without additional substituents; methanethiol, ethanethiol, 1-propanethiol, 2-propanethiol, 1-butanethiol, 2-butanethiol, 2-methylpropan-2-thiol, any and all other primary, secondary, and tertiary thiols with and without additional substituents; thioacetic acid, any and all other —S— and —O— thio acids with and without additional substituents; ammonia, methylamine, ethylamine, dimethylamine, diethylamine, N-ethylmethylamine, any and all other primary and secondary amines with and without additional substituents; any and all linear and branched acid amides with and without additional substituents; any and all linear and branched diacid amides with and without additional substituents; any and all diols, dicarboxylic acids, dithiols, diamines, thioalchols, aminoalcohols, aminothiols, hydroxycarboxylic acids, hydroxythio acids, hydroxyamides, and triols, of any size with and without any additional substituents, etc.; aprotic polar liquids, solvents, solutions, suspensions, emulsions, gels, plasmas, and salts (i.e. any and all compounds which have one or more net polarizing dipole moments but do not contain a functional group with a labile hydrogen proton) including but not limited to methyl methanoate, methyl ethanoate, methyl proponoate, ethyl methanoate, propyl methanoate, ethyl ethanote, any and all other dialkyl esters with and without additional substituents; methanol, ethanal, propanal, 2-propanone, butanal, 2-butanone, pentanal, 2-pentanone, 3-pentanone, any and all other aldehydes and ketones with and without additional substituents; dimethyl formamide, any and all other disubstituted amides with and without additional substituents; dimethyl sulfoxide, any and all other disubstituted sulfoxides with and without additional substituents; methyl bromide, methyl iodide, ethyl bromide, ethyl iodide, propyl bromide, propyl iodide, any and all other alkyl halides with and without additional substituents; methyl cyanide, ethyl cyanide, any and all other cyanides with and without additional substituents; tetrahydrofuan, 1,4-dioxane, N-methyl-2-pyrrolidone, any and all other furans, dioxanes, and pyrroles with and without additional substituents; trimethyl phosphate, trimethyl phosphite, etc.; nonpolar liquids, solvents, solutions, suspensions, emulsions, gels, plasmas, and salts (i.e. any and all compounds which do not have net polarizing dipole moments) including but not limited to pentane, hexane, heptane, octane, nonane, decane, undecane, dodecane, tridecance, tetradecane, pentadecane, hexadecane, heptadecane, octadecane, nonadecane, isocane, any and all other alkanes and paraffins, small, large, branched, linear, with or without additional substituents, etc.; symmetric ethers, silicones, hydrides, etc.; other solid electrolyte promoting and forming materials, electrolyte diluting materials, ion scavenging materials, surfactant materials, flame extinguishing and flame retardant materials, ion solvation disrupting materials (i.e. any material containing one or more functional groups with basic electron lone pairs (N:, :0:, :S:, vinyl groups, etc.) which may interact with the solvation structure of the working ions), viscous and thickening or thinning materials, electrolyte absorbent and superabsorbent materials, gas generating materials (i.e. one or multiple compounds which produce gas associated with thermal, catalytic, chemical, or electrochemical decomposition, reaction, phase change or a multiplicity said phenomena), acidic materials, basic materials, water, aqueous solutions or suspensions of inorganic or organic materials, and any combinations of the aforementioned examples that may be used alone or be combined with each other or other compounds not mentioned here. We reiterate and stress that the aforementioned examples of functional solids, liquids, gases, solutions, suspensions, emulsions, foams, gels, plasmas, or combinations of, should not be considered as limiting. It is expected that a wide variety of compounds, compound combinations, and materials may serve to mitigate heat generation or accrued temperature or prevent, reduce, retard, or extinguish a fire upon triggered response to a mechanically or thermally abusive event by a cell case or cell case component structured with thermal runaway mitigating or fire mitigating materials; container, component, or element internal to the cell case supporting thermal runaway mitigating or fire mitigating materials; devices or components delivering thermal runaway mitigating or fire mitigating materials into the battery cell from outside the cell case; or pipes, ducts, tubes, and channels hosting thermal runaway mitigating or fire mitigating materials.

1. A battery comprising:
a cathode comprising at least one charge collector;
an anode comprising at least one charge collector;
a separator;
a cell case; and
an electrolyte;
wherein the cathode and anode are formed of active material positioned on charge collectors.

2. The battery of claim 1, wherein the charge collector contains at least one weakening feature selected from the group consisting of bumps, notches, grooves, cracks, voids, sharp openings, folds, ridges, valleys, and hollow cross-section profiles.

3. The battery of claim 2, wherein the charge collector is configured to be broken apart as the battery is subjected to mechanical abuse or thermal abuse or both mechanical and thermal abuse, thereby separating internal shorting sites.

4. The battery of claim 2, wherein configurations of the weakening features include at least one selected from the group consisting of straight lines, parallel lines, perpendicular lines, curved lines, dots, openings with wavy edges, sharp openings, hollow cross-sectional profiles, bridges, islands, and joints.

5. The battery of claim 4, wherein configurations of the weakening features include at least two selected from the group consisting straight lines, parallel lines, perpendicular lines, curved lines, dots, openings with wavy edges, sharp openings, hollow cross-sectional profiles, bridges, islands, and joints.

6. The battery of claim 1, wherein the charge collector contains at least one locally heterogeneous material selected from the group consisting of weakening metals, temperature sensitive metals, alloys, ceramics, polymers, glass, carbon materials, elastomers, and composites.

7. The battery of claim 6, wherein the charge collector is configured to increase impedance as the battery is subjected to mechanical abuse or thermal abuse or both mechanical and thermal abuse.

8. The battery of claim 7, wherein the charge collector contains at least two locally heterogeneous materials selected from the group consisting of weakening metals, temperature sensitive metals, alloys, ceramics, polymers, glass, carbon materials, elastomers, and composites.

9. The battery of claim 1, wherein the charge collectors of the cathode and anode are arranged in a mismatched placement with no overlapping area.

10. A system comprising:
a cathode comprising a current collector;
an anode comprising a current collector;
a separator;
a cell case; and
an electrolyte;
wherein at least one of the group consisting of the cathode, the anode, the cell case, and the separator comprises a failure feature configured to fail in response to at least one of the group consisting of thermal abuse and mechanical abuse.

11. The system of claim 10 wherein the failure feature is at least one of the group consisting of cracks, vacancies, wave shapes, protrusions, trenches, and indentations.

12. The system of claim 10 wherein the failure feature is at least one of the group consisting of locally anisotropic and heterogeneous.

13. The system of claim 10 wherein the failure feature is mechanically triggered upon mechanical abuse; and configured to increase impedance.

14. The system of claim 10 wherein the failure feature comprises two or more different materials.

15. The system of claim 10 wherein one of the group consisting of the cathode, the anode, the cell case, and the separator comprises a second failure feature configured to fail in response to at least one of the group consisting of thermal abuse and mechanical abuse.

16. The system of claim 15, wherein the failure feature and the second failure feature differ in at least one of the group consisting of pattern, shape, size, orientation, and material.

17. The system of claim 10, wherein the failure feature is created by surface treatment.

18. The system of claim 10, wherein the current collector comprises alternating current collecting components and non-current-collecting components.

19. The system of claim 18, wherein the alternating current collecting components and non-current collecting components are at least one of the group consisting of locally anisotropic and heterogeneous.

20. The system of claim 10, wherein the failure feature comprises a container containing mitigation material, wherein the container is configured to fail in response to at least one of the group consisting of thermal abuse and mechanical abuse by releasing the mitigation material.

21. The system of claim 20 where the mitigation material is at least one of the group consisting of thermal runaway mitigating material and fire mitigating material.

22. The system of claim 20, wherein the container is positioned in a location that is fixed relative to an electrode stack.

23. The system of claim 20, wherein the container is positioned in a location that is fixed relative.

24. The system of claim 20, wherein the container is positioned in a location external to the cell case and releases mitigation material into the battery cell in response to at least one of the group consisting of mechanical abuse and thermal abuse.

25. The system of claim 24, wherein the container is positioned in a location that is fixed relative a thermal management component.

26. The system of claim 25, wherein the thermal management component iscoupled to a thermal management computer operating system.

27. The system of claim 20, wherein the container comprises at least one of the group consisting of pouches, containers, pipes, ducts, channels.

28. The system of claim 20, wherein the container is an element of at least one of the group consisting of a thermal management system, battery cell support system, battery module, and pack wall.

29. The system of claim 20, wherein the container is an element of at least one of the group consisting of cleaning component, fuel-containing component, lubricant-containing component, and liquid-containing structure or component external to the battery cell.
